(19) United States
(12) Patent Application Publication
(10) Pub. No.: US 2003/0004740 A1
(43) Pub. Date: Jan. 2, 2003

(54) Pet care products and method of providing pet care products, services and information

(76) Inventors: Bradley Jade Dickey, Batesville, IN (US); Rodger Allen Jones, Indianapolis, IN (US); Chris Lowery, Batesville, IN (US); Darryl M. Maslar, Batesville, IN (US)

Correspondence Address: WOOD, HERRON & EVANS, L.L.P., 2700 Carew Tower, Cincinnati, OH, 45202, US

(21) Appl. No.: 10/021,665

(22) Filed: Dec. 7, 2001

Related U.S. Application Data
(63) Continuation-in-part of application No. 09/909,921, filed on Jul. 20, 2001.
(60) Provisional application No. 60/254,123, filed on Dec. 8, 2000.
(60) Provisional application No. 60/219,675, filed on Jul. 21, 2000.

(51) Int. Cl. G06F 17/60

(52) U.S. Cl. 705/1

(57) ABSTRACT

A method of providing pet care products, services and information comprises receiving pet care products, services and information from a supplier, and, as a preferred provider, dispensing the pet care products, services and information to pet owners. A method of equipping a preferred provider with pet care products, services and information to be dispensed to pet owners comprises selecting a preferred provider and supplying the preferred provider with pet care products, services and information to be dispensed by the preferred provider to pet owners. The pet care products, services and information can be for pet life care or pet death care or both pet life care and pet death care. The preferred provider can be an individual veterinarian or a network of veterinarians, an individual pet store or a nationwide chain of pet stores, an individual pet cemetery or a nationwide chain of pet cemeteries or an animal humane shelter or nationwide chain of animal shelters.

### RELATED APPLICATIONS

This application is a continuation of application Serial No. 60/254,123, and a continuation-in-part of application Ser. No. 09/909,921, itself a continuation-in-part of application Serial No. 60/219,675, all of which are hereby incorporated by reference herein.

### FIELD OF THE INVENTION

This invention relates generally to the pet care industry, and more particularly to the pet life and death care industry and the products, services and information therefore and the methods and means of providing same.

### BACKGROUND OF THE INVENTION

Pet life care is a growing industry. Four stages of the pet life cycle have been identified: newborn pet, young pet, mature/middle aged pet and senior pet. The needs of pet owners for pet life care products, services and information change during this pet life cycle.

While the pet life care industry has made strides in providing pet owners with products and services commensurate with the various stages of the life of a pet during its life cycle, at present there is no comprehensive system or approach for disseminating the pet life care products, services and information to pet owners.

Pet death care is also a growing industry. Pet owners become closely attached to their pets, not unlike the way friends and family become closely attached to one another. As a consequence, there is a need for pet owners to grieve when their pets die and to memorialize the pet after death.

Currently there is no comprehensive system or approach to disseminating pet death care products, services and information to pet owners upon the death of their pets. Families, senior citizens and especially children all develop close personal relationships with their pets. As a consequence, when their pets die, there is a need to provide them aftercare information, guidance and counseling in much the same manner as is provided to family and friends of a deceased human loved one. Information in the areas of aftercare, i.e. cremation and burial, and memorialization, i.e. vaults, caskets, urns, memorial markers and other memorial products, and grief counseling are desired. The difficulty is that current offerings of such information are extremely fragmented and not systematically centralized. As a result, obtaining such information and guidance is difficult and bothersome, difficulty and bother being of course the last things a grieving pet owner needs to be subjected to at the time of pet loss.

### SUMMARY OF THE INVENTION

The present invention provides a number of pet care products as well as methods of providing pet care products, services and information and of equipping a preferred provider with pet care products, services and information to be dispensed to pet owners.

The method of providing pet care products, services and information comprises receiving pet life or death or life and death care products, services and information from a supplier, and, as a preferred provider, dispensing the pet care products, services and information to pet owners. The method of equipping a preferred provider with pet care products, services and information to be dispensed to pet owners comprises selecting a preferred provider and supplying the preferred provider with pet life or death or life and death care products, services and information to be dispensed by the preferred provider to pet owners. Preferably the preferred provider is an individual veterinarian or a network of veterinarians. Optionally the preferred provider could be an individual pet store or a nationwide chain or franchise of pet stores. Again optionally the preferred provider could be an individual pet cemetery or a nationwide chain of pet cemeteries. Further optionally the preferred provider could be an individual animal humane shelter or a nationwide chain of animal shelters.

The preferred provider would offer the pet owner such products as pet caskets, urns, memorial markers and products, etc., and grief consoling printed matter such as children's brochures or coloring books dealing with pet loss, etc. The preferred provider would also offer the pet owner such disposition services as cremation and burial, and funeral or other memorial services, etc. The preferred provider would further offer the pet owner information about grief counseling and death/grief support groups, etc.

The present invention thus provides a much needed centralized, systematic approach to dispensing pet care products, services and information, as well as new and novel pet care products.

These and other features and advantages of the present invention will become more readily apparent during the following detailed description taken in conjunction with the exhibits herein, in which:

### BRIEF DESCRIPTION OF THE DRAWINGS OF THE INVENTION

FIG. 1 is a flowchart of a method of dispensing pet care products, services and information according to the principles of the present invention:

FIG. 2 is a block diagram of a World Wide Web Internet site of content for use in dispensing pet care products, services and information according to the method of FIG. 1;

FIG. 3 is a pet product catalog of FIG. 2;

FIGS. 4 and 5 are pet caskets from the FIG. 3 catalog;

FIGS. 6-13 are pet urns from the FIG. 3 catalog;

FIG. 14 is a pet memorial plaque from the FIG. 3 catalog;

FIGS. 15-17 are pet memorial frames from the FIG. 3 catalog;

FIG. 18 is a pet garden memorial stepping stone from the FIG. 3 catalog;

FIG. 19 is pet figurines from the FIG. 3 catalog;

FIG. 20 is a pet memento chest from the FIG. 3 catalog;

FIG. 21 is pet sympathy cards from the FIG. 3 catalog;

FIG. 22 is a pet memorial mouse pad and a pet photo album from the FIG. 3 catalog;

FIG. 23 is pet loss brochures from the FIG. 2 website;

FIGS. 24-27 are retail pet memorial product displays;

FIGS. 28 and 29 are retail product displays for displaying pet life care products, services and information and/or pet death care products, services and information;

FIG. 30 is pet memorial picture frames;

FIG. 31 is additional picture frames, as well as memorial paper weights and photo album;

FIG. 32 is personalized pet wall hanging quilts, throw pillows and portrait;

FIG. 33 is pet figurines, a St. Francis medal and a St. Francis statue;

FIG. 34 is garden memorial rocks, stones and stepping stones;

FIG. 35 is a paw stepping stone, create-a-memory stepping stone, pet garden flags and a tabletop fountain;

FIG. 36 is cremation containers;

FIG. 37 is additional cremation containers;

FIG. 38 is further cremation containers;

FIG. 39 is yet further cremation containers;

FIG. 40 is burial containers, boxes and baskets, and children and adult pet loss books;

FIGS. 41-44 are selected ones of the products of FIGS. 30-40 which can be utilized during the life of a pet, as well as to memorialize the pet after death;

FIG. 45 is a pet travel kit and petware; and

FIG. 46 is the St. Francis medal and St. Francis statute of FIG. 33 which can be utilized during the life of a pet as well as to memorialize the pet after death, and children and adult relationship books.

### DETAILED DESCRIPTION OF A PREFERRED EMBODIMENT OF THE INVENTION

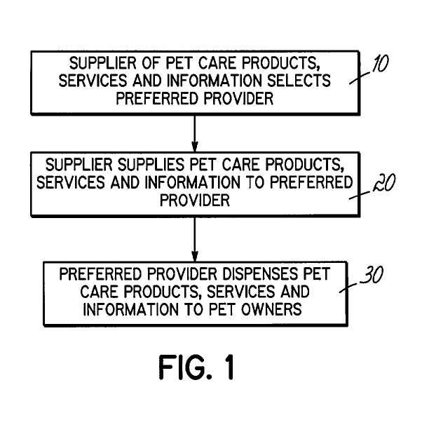

Referring first to FIG. 1, there is illustrated a flow chart of a method of dispensing pet care products, services and information according to the principles of the present invention. The pet care products, services and information can include pet death care products, services and information and/or pet life care products, services and information.

The FIG. 1 method comprises an initial step 10 wherein the supplier of the pet care products, services and information selects a preferred provider to provide or dispense such products, services and information to pet owners. In a second step 20 the supplier supplies the pet care products, services and information to the preferred provider selected in step 10. Finally, in step 30 the preferred provider dispenses the pet care products, services and information to the pet owners.

The preferred provider can be an individual veterinarian or a network of veterinarians, an individual pet store or a nationwide chain or franchise of pet stores, an individual pet cemetery or a nationwide chain of pet cemeteries or an animal humane shelter/humane society or nationwide chain of animal humane shelters/humane societies.

The preferred provider could offer the pet owners such death care products as pet caskets, urns, memorial markers and products, etc., and grief consoling printed matter such as children's brochures or coloring books dealing with pet loss, etc. The preferred provider could also offer the pet owner such death care services as disposition services, that is cremation and burial services, and funeral or other memorial services, etc. The preferred provider could further offer the pet owner information about grief counseling and death/grief support groups, etc.

The cremation services offered to pet owners could be made available through any of four sources of such services. First, pet cremations could be performed utilizing a crematory owned by the supplier of the pet death care products, services and information, for example the Assignee of the present invention. Second, pet cremations could be performed in a crematory owned by a humane society. A percentage of the fees collected for the cremations could be paid to the humane society in return for use of the excess capacity of their crematory. In addition, the supplier and the humane society could “co-brand” to leverage both presences with veterinarians and consumers. The scope of informational materials provided could be broadened to include information regarding pet adoption, pet adoption services available through the humane society and information regarding responsible pet ownership. Third, pet cremations could be performed in a crematory owned by a direct competitor of the supplier of pet death care products, services and information. A percentage of the fees collected for the cremations could be paid to the competitor in return for use of the excess capacity of their crematory. Fourth, pet cremations could be performed in a crematory owned by a retort manufacturer. A percentage of the fees collected for cremations could be paid to the retort manufacturer instead of purchasing the retort equipment directly.

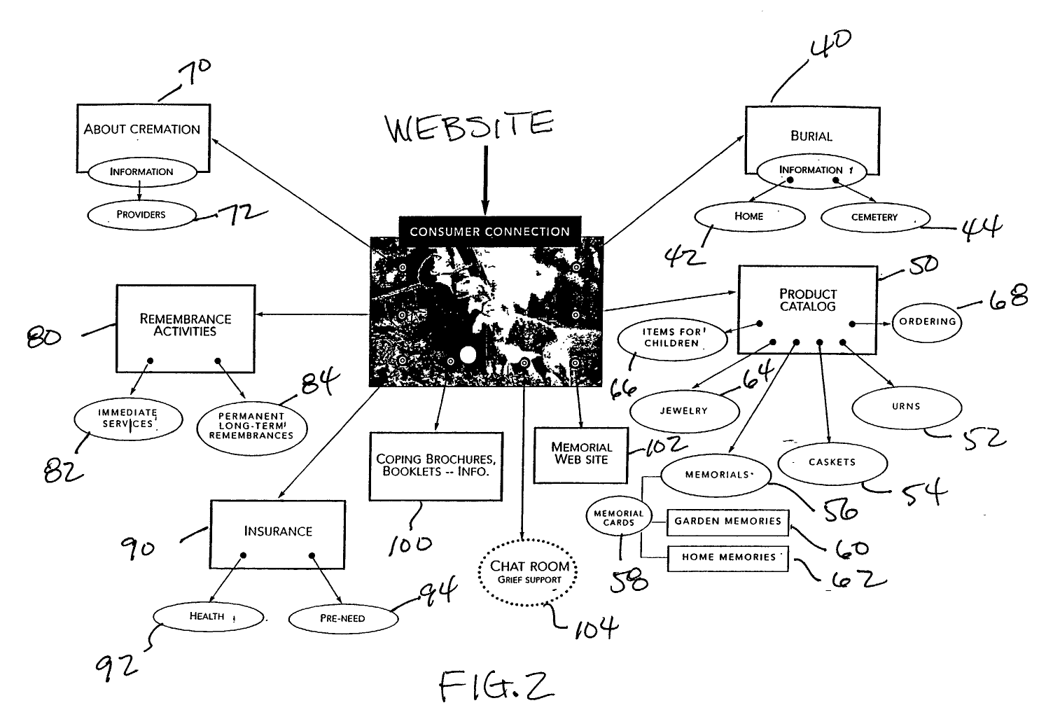

Referring now to FIG. 2, there is illustrated a block diagram of a World Wide Web internet site of content for use in dispensing the pet care products, services and information according to the method of FIG. 1. The web site content can include pet burial information 40 including home burial information 42 and cemetery burial information 44. The web site content can also include a pet product catalog 50 which could include a selection of cremation urns 52, caskets 54, memorials 56 including cards 58, garden memories 60 and home memories 62, jewelry 64, children's items 66 and ordering information 68. The content can further include pet cremation information 70 including providers thereof 72. The content can further include remembrance activities 80 such as immediate services 82 and permanent long-term remembrances 84. The content can further include insurance information 90 including pet health insurance 92 and pet pre-need funeral insurance 94. Additional web site content could include coping brochures, booklets and the like 100, a memorial web site 102 and a chat room 104 providing grief support.

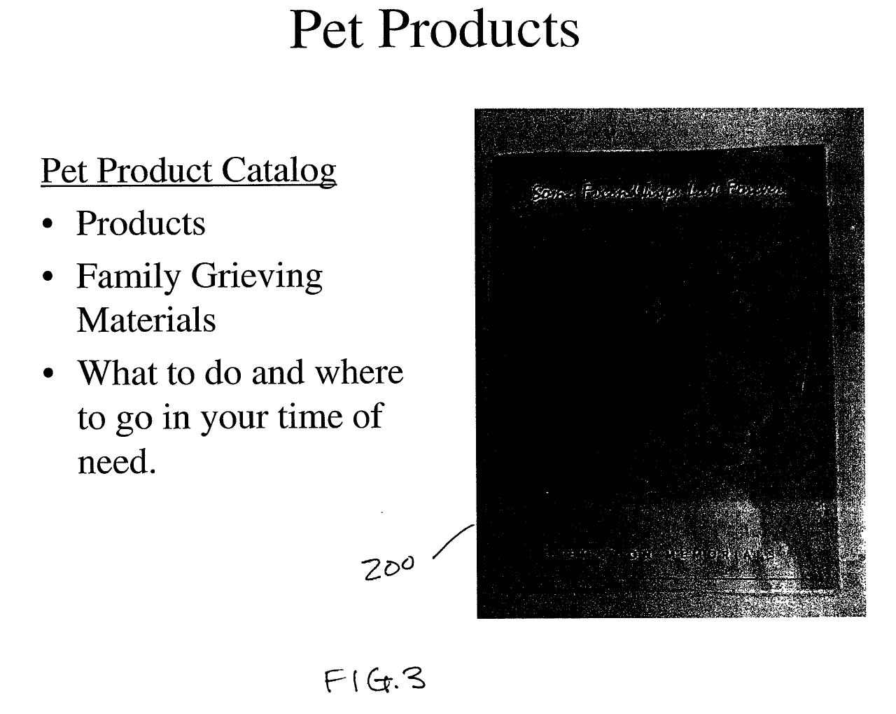

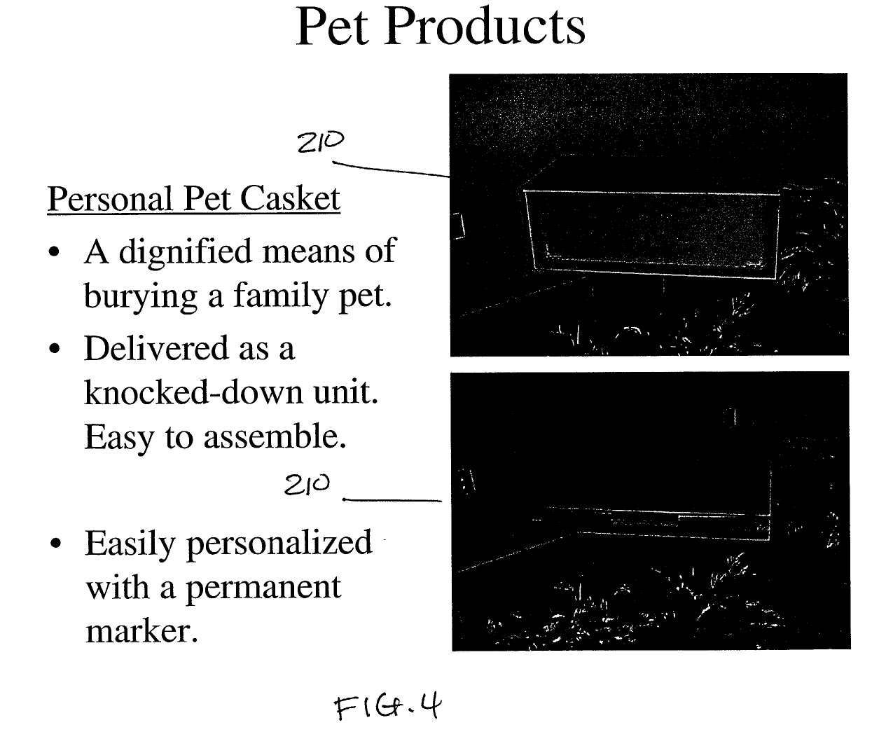

Referring to FIG. 3 there is illustrated a pet catalog 300 from the content of the FIG. 2 World Wide Web internet site. The pet catalog 300 could include products, family grieving materials, and other information such as what to do and where to go in one's time of need. FIGS. 4-23 illustrate a number of such products, materials and information.

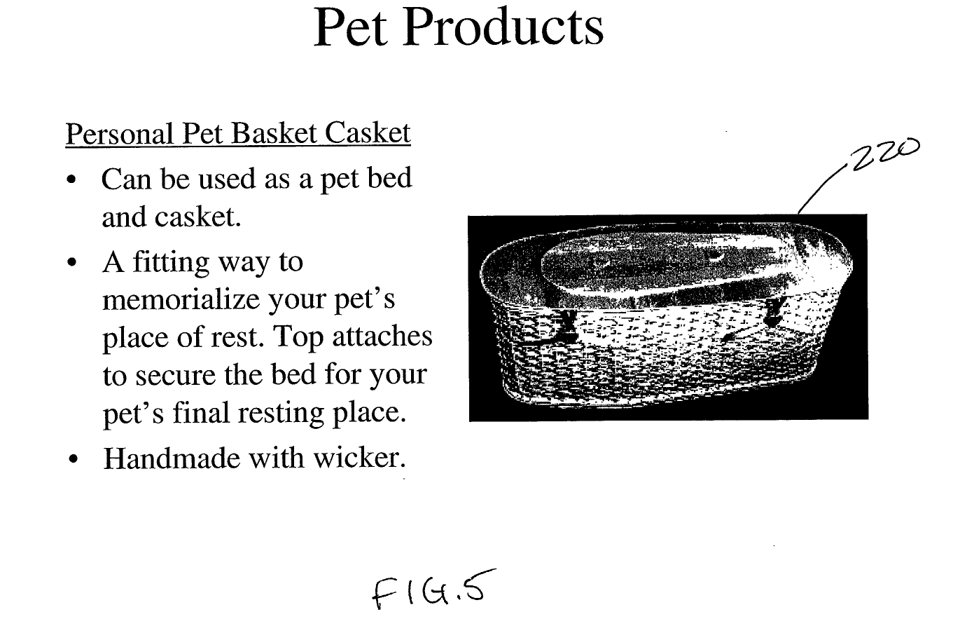

For example, FIGS. 4 and 5 are pet caskets from the FIG. 3 catalog. FIG. 4 is a so-called knock down unit 210 which is shipped in a knocked down state and is assembled on site. The unit 210 provides a dignified means of burying a family pet, and is easily personalized with a permanent marker. FIG. 5 illustrates another pet casket, a so-called pet basket casket. handmade of wicker, which can be used as a pet bed and casket. A top attaches to the lower bed portion to form the casket.

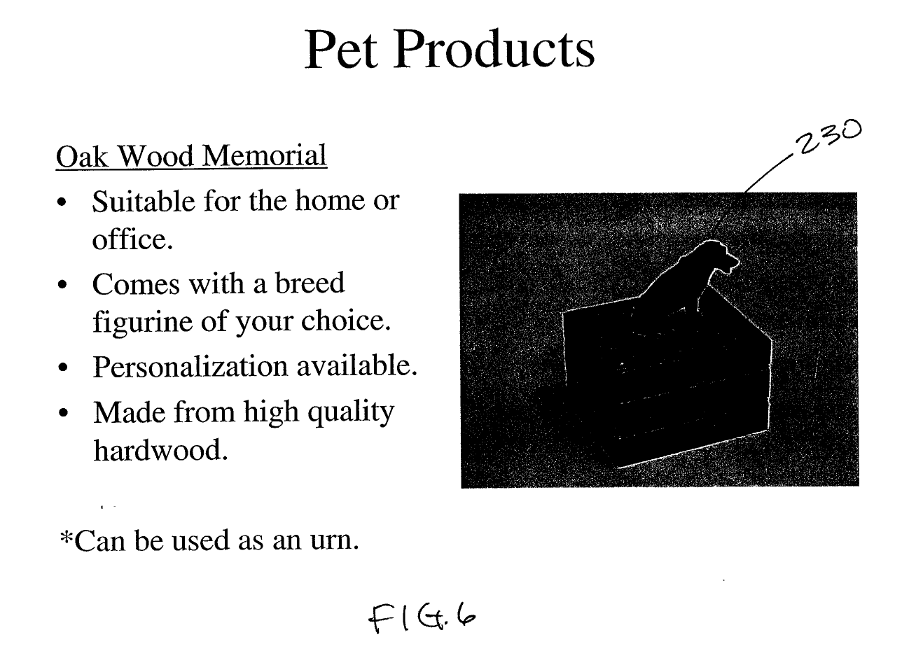

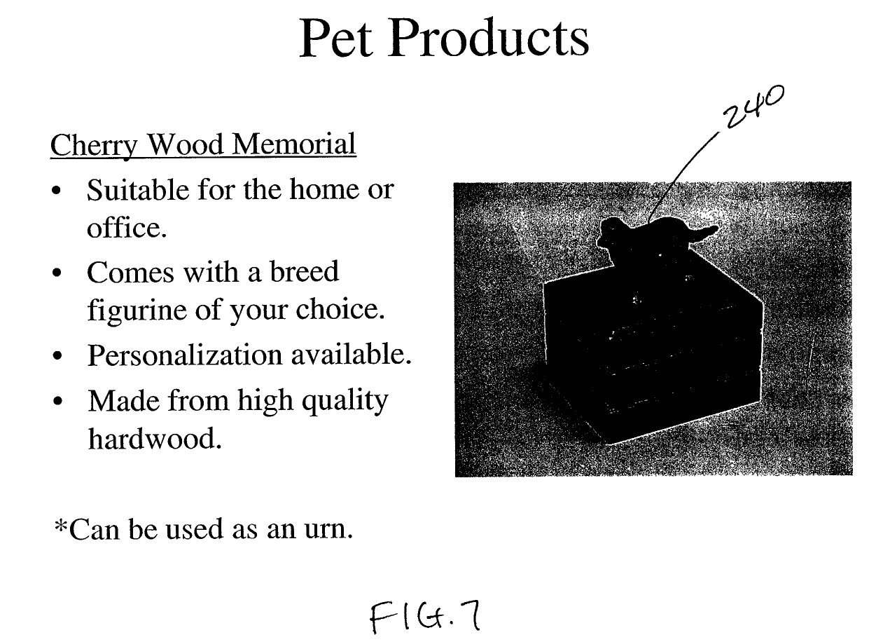

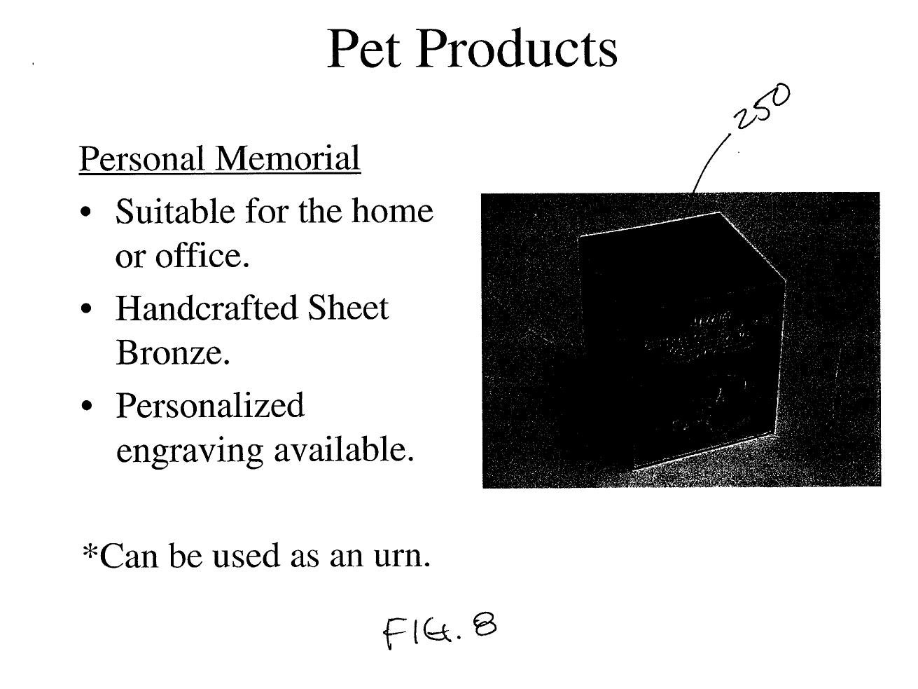

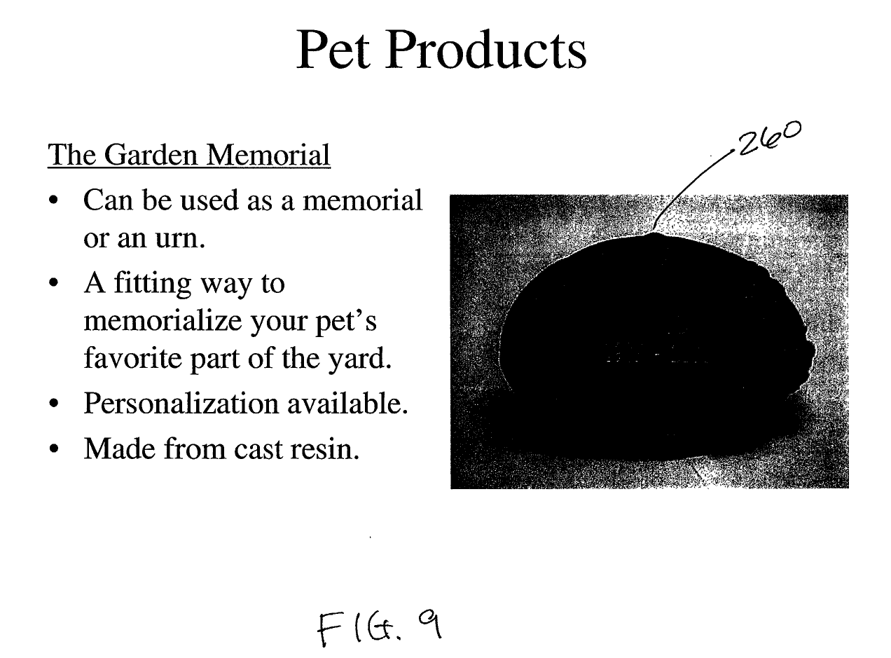

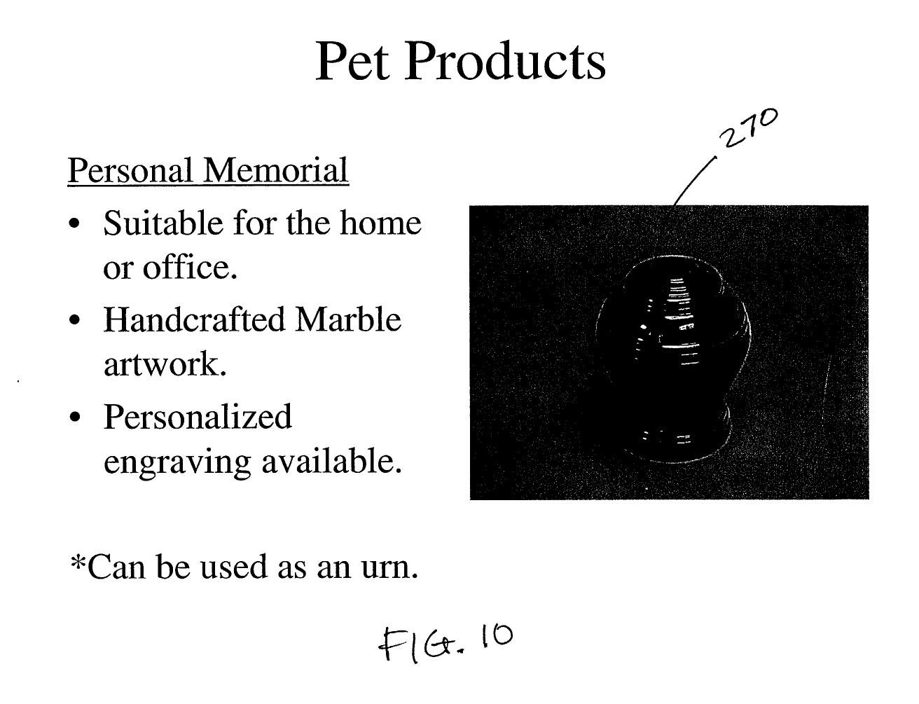

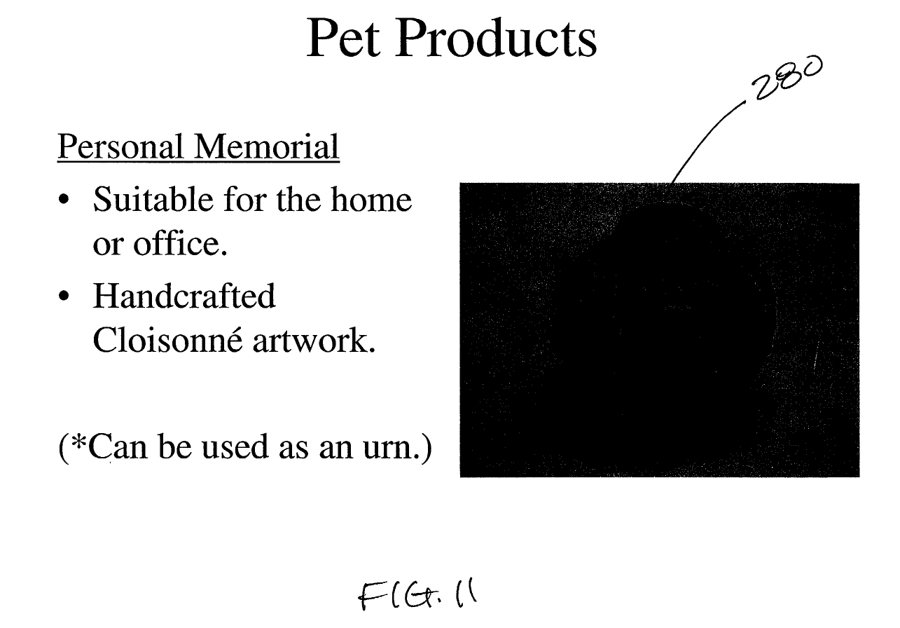

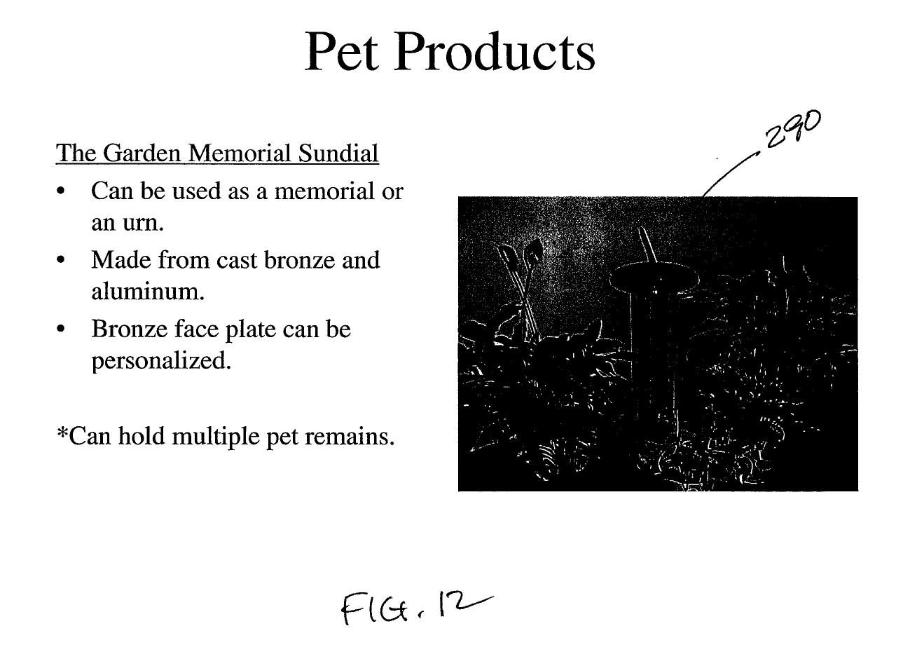

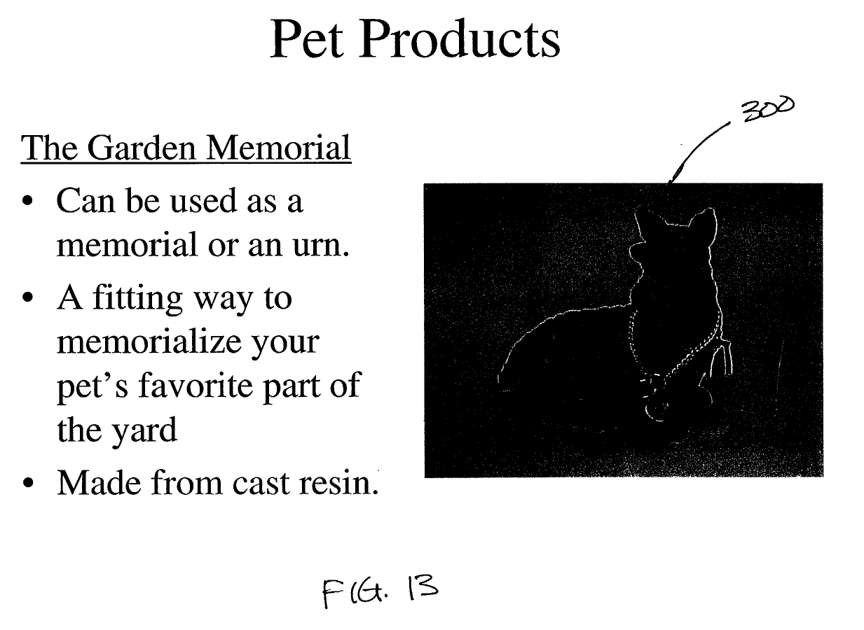

FIGS. 6-13 are pet urns from the FIG. 3 catalog. The FIG. 6 urn 230 is made from high quality hard wood, for example oak, and is suitable for the home or office. The urn 230 comes with the dog breed figurine of one's choice, and personalization is available. The FIG. 7 urn 240 is similar to the FIG. 6 urn 230 except that the urn 240 is cherry instead of oak. The FIG. 8 urn 250 is hand crafted of sheet bronze. Like the urns 230 and 240, it can be personalized, i.e. engraved, and is also suitable for home or office. The FIG. 9 urn 260 is made from cast resin, and can be used as a memorial, an urn or both, such as for example in one's garden. Like the prior urns, the urn 260 can be personalized and it is a fitting way to memorialize one's pet's favorite part of the yard. The FIG. 10 urn 270 is hand crafted of marble. Like the other urns, the urn 270 is personalizable via engraving and is suitable for the home or office. The FIG. 11 urn 280 is similar to the urn 270 but is hand crafted of cloisonné. The FIG. 12 urn 290 is made of cast bronze and aluminum and can be used as a memorial, urn, or both, preferably in one's garden. The urn 290 includes a bronze face plate that can be personalized through engraving. Finally, FIG. 13 illustrates an urn 300 made from cast resin that can also be utilized as a memorial, urn, or both, again preferably in one's garden, and is a fitting way to memorialize one's pet's favorite part of the yard.

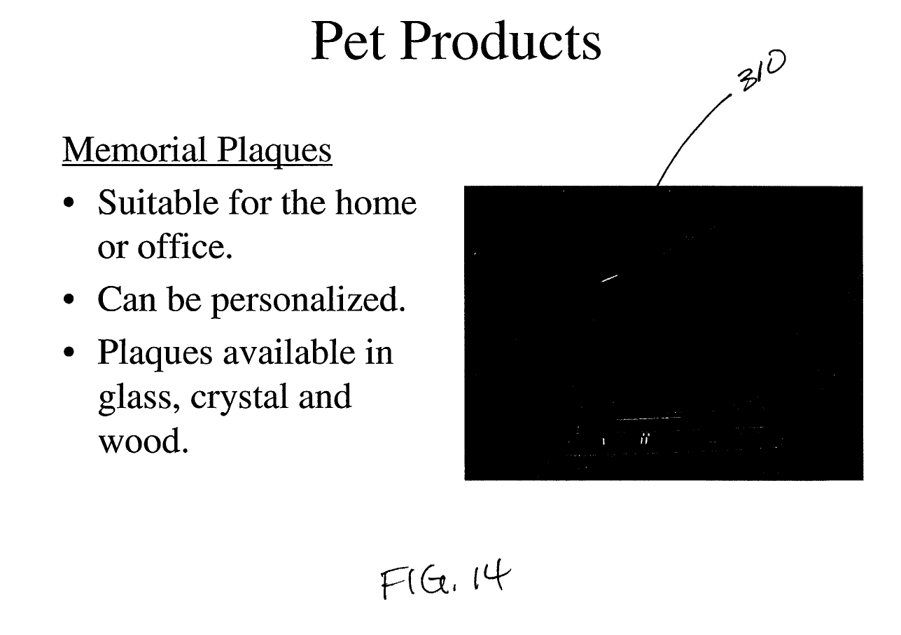

FIG. 14 is a memorial plaque 310 made of glass, crystal and wood. The plaque can be personalized and is suitable for home or office.

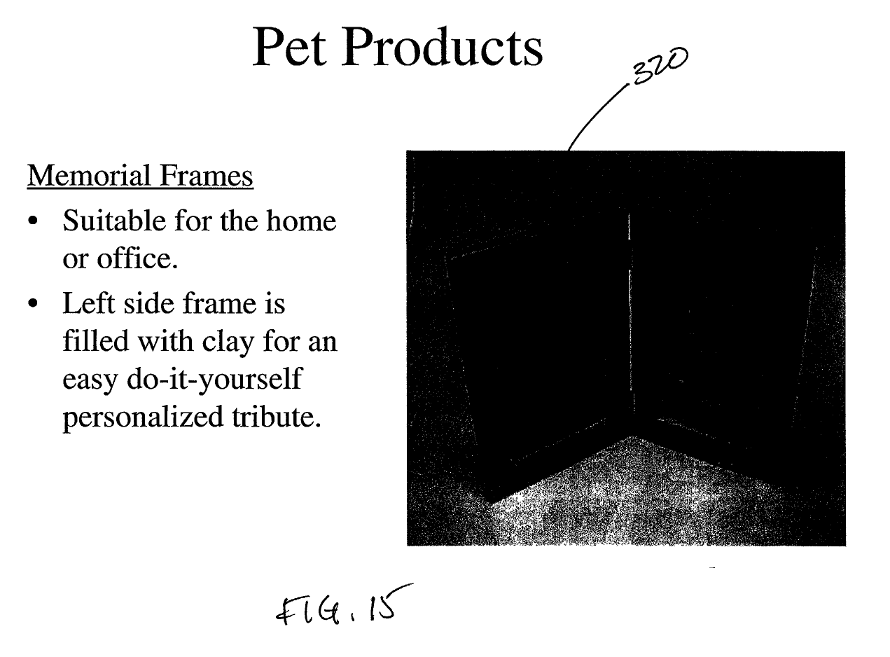

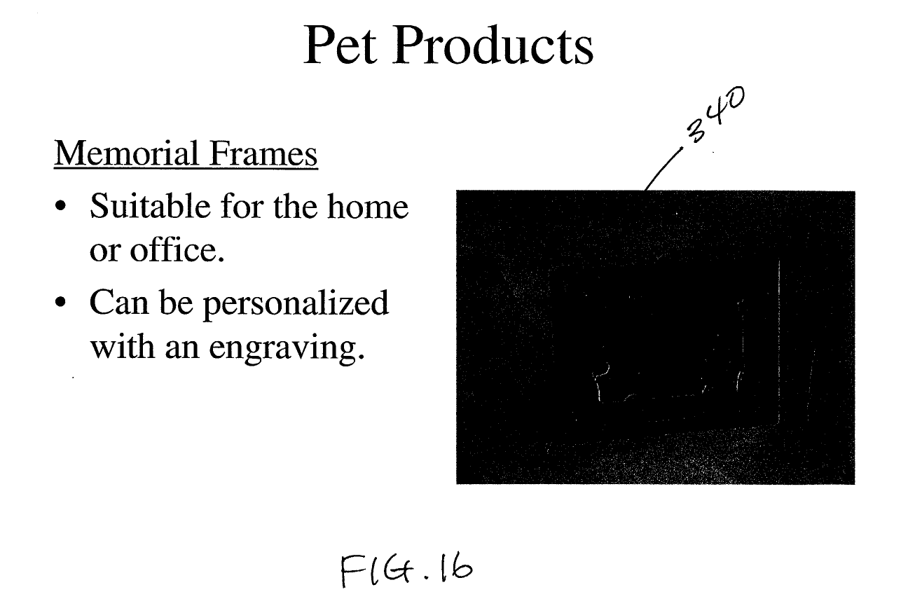

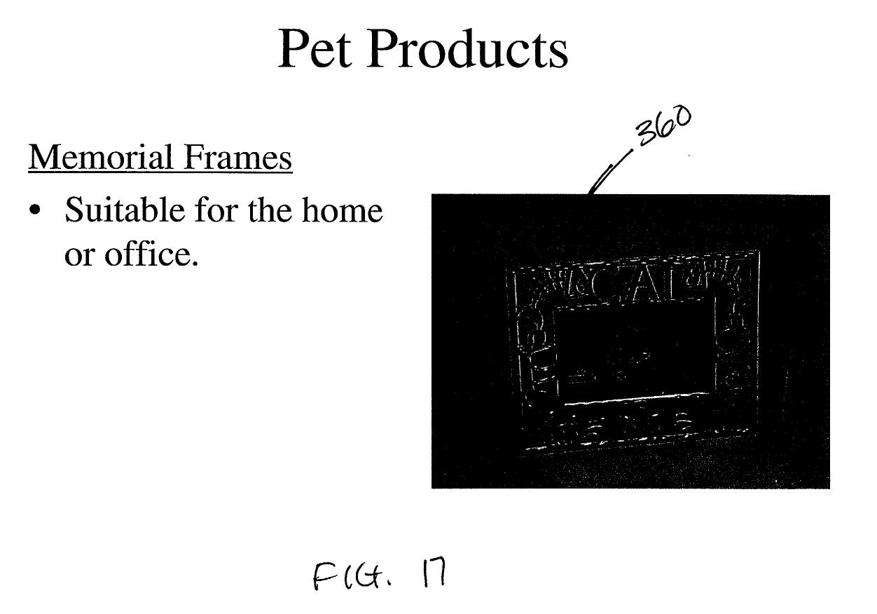

FIGS. 15-17 are pet memorial frames. The FIG. 15 frame 320 includes a picture frame on one side and is filled with clay on the other side facilitating an easy do-it-yourself personalized tribute to one's pet, for example paw print, etc. The frame 320 is suitable for home or office. The FIG. 16 frame 340 can be personalized with an engraving and is likewise suitable for home or office. The FIG. 17 frame 360 is particularly adapted for cats and is also suitable for home or office.

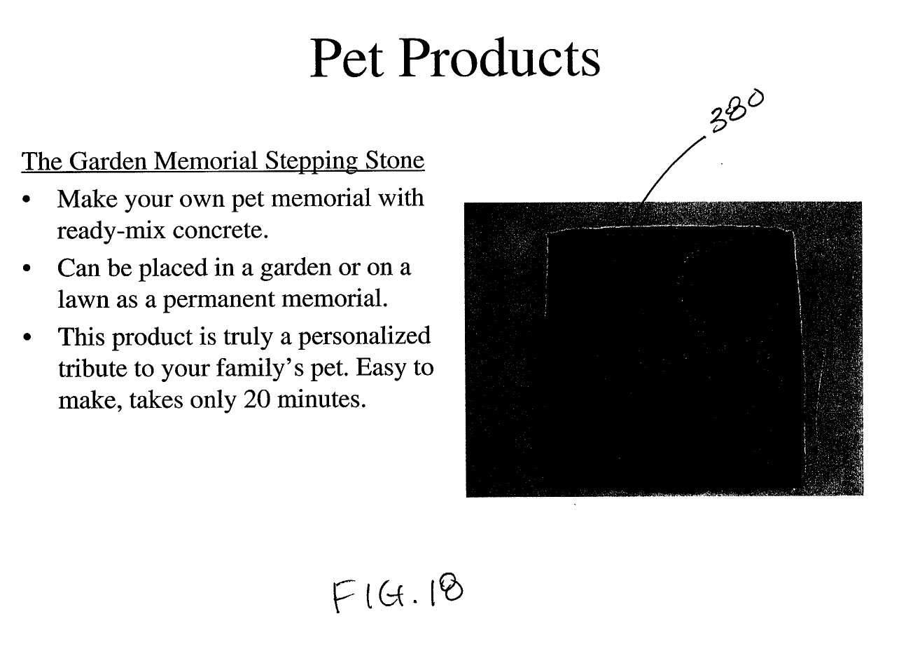

FIG. 18 is a garden memorial stepping stone. The stepping stone 380 is a do-it-yourself create-your-own pet memorial made with ready mix concrete. The stepping stone 380 can be placed in a garden or on a lawn as a permanent memorial to the pet.

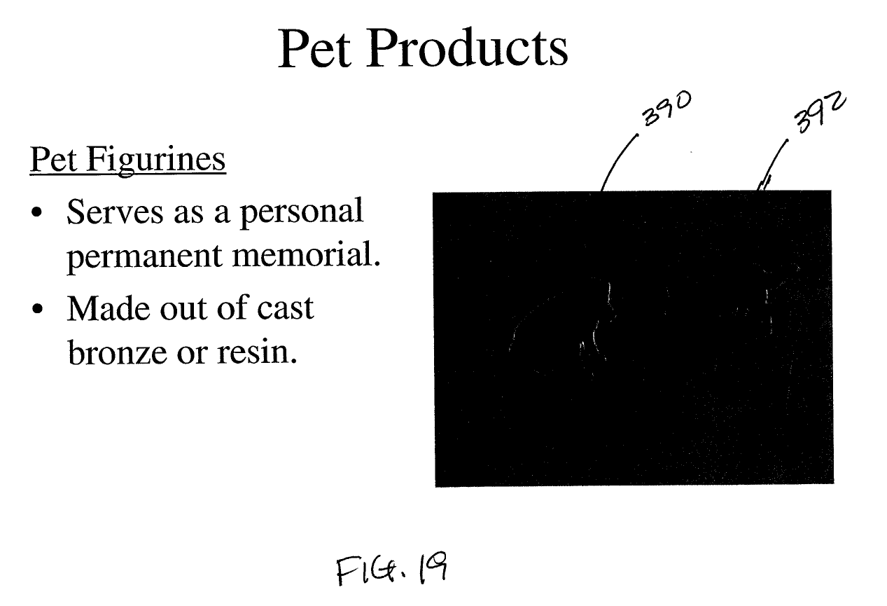

FIG. 19 is pet figurines 390, 392 made out of cast bronze or resin and serving as a personal permanent memorial.

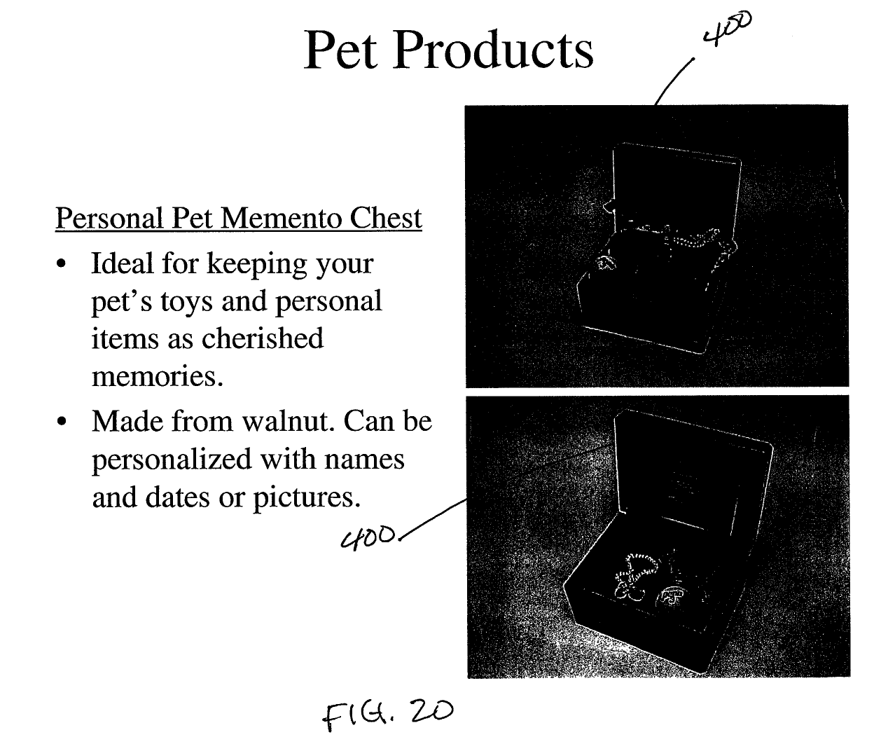

FIG. 20 is a pet memorial chest 400, made from walnut, and personalized with names, dates or pictures. The chest 400 is ideal for keeping a pet's toys and personal items as cherished memories.

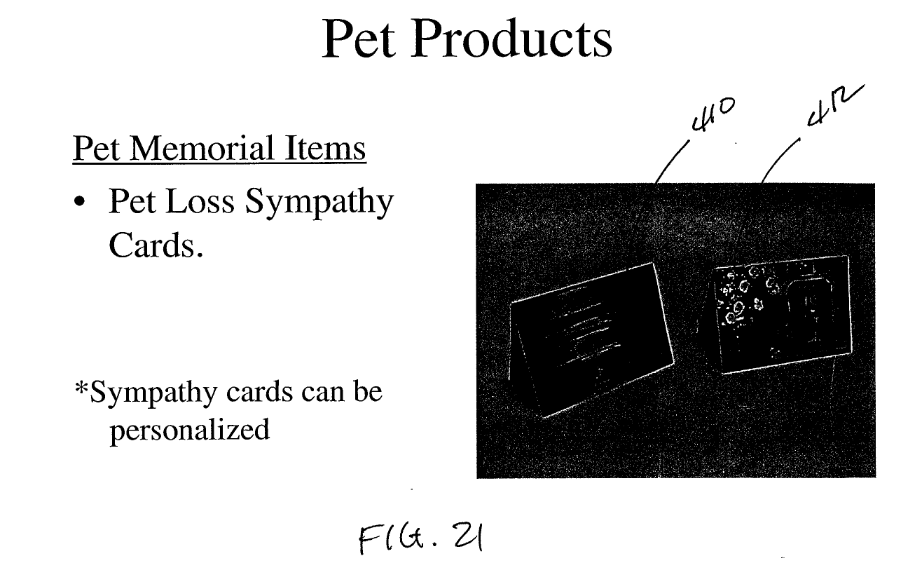

FIG. 21 is pet loss sympathy cards 410 and 412.

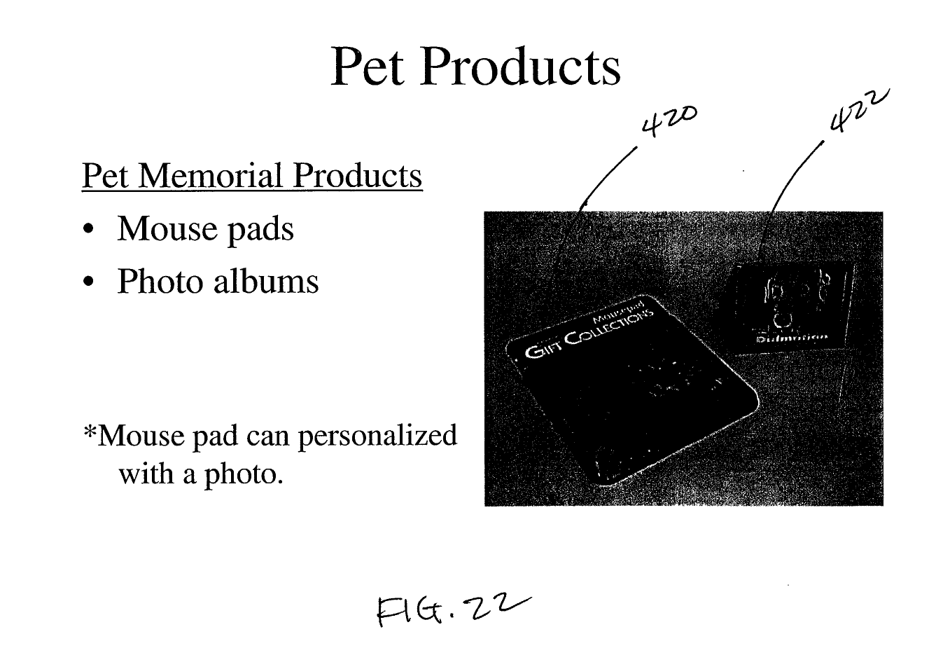

FIG. 22 is a pet memorial mouse pad and a pet memorial photo album 422, both of which can be personalized with a photo.

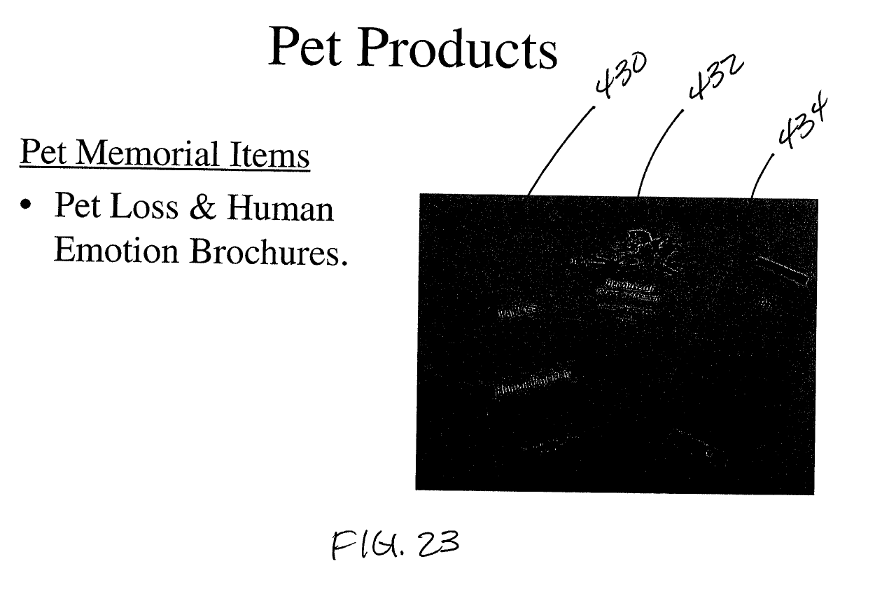

FIG. 23 is pet loss and human emotion brochures 430, 432 and 434.

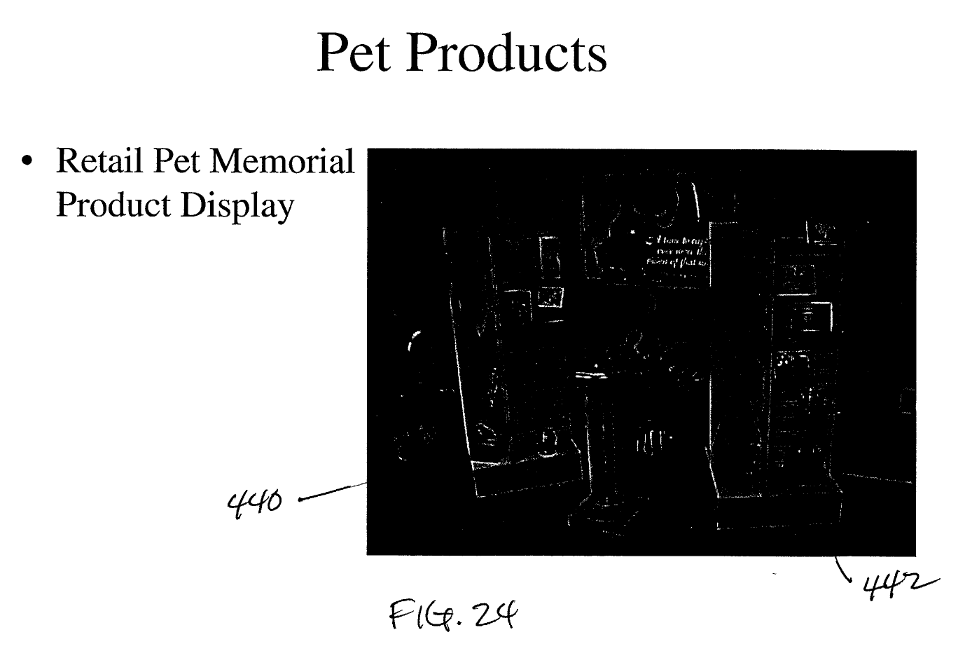

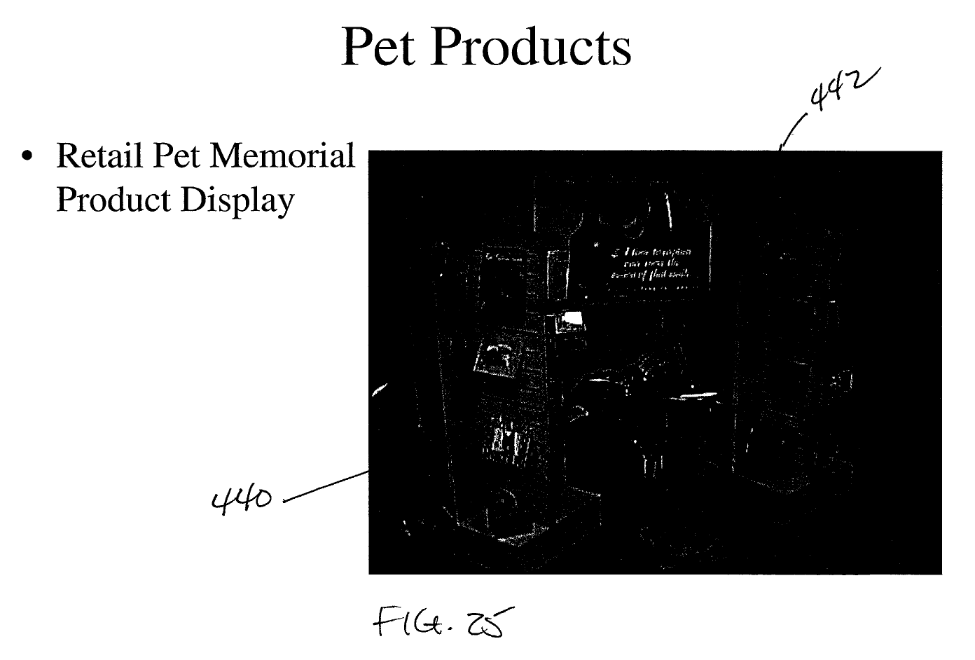

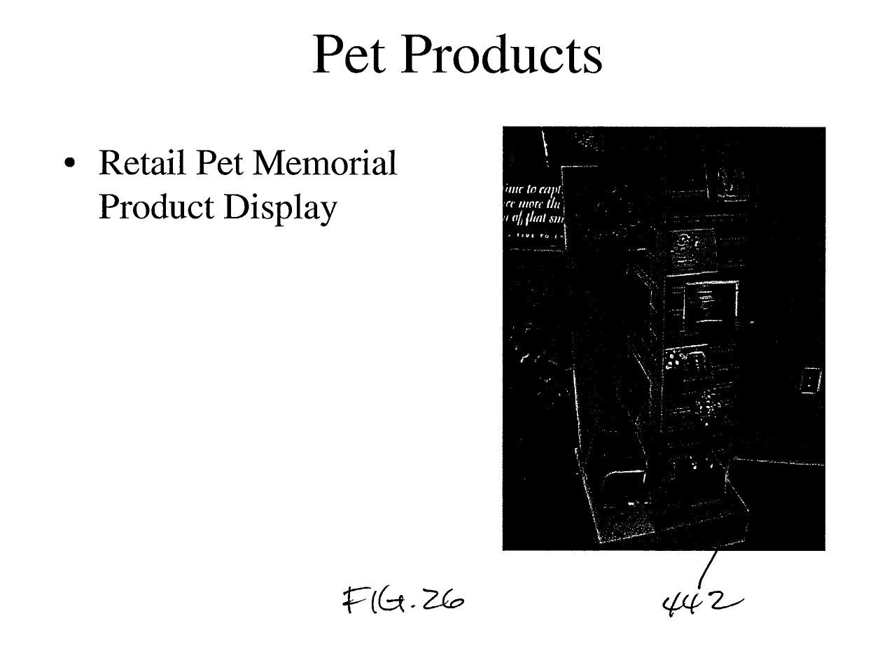

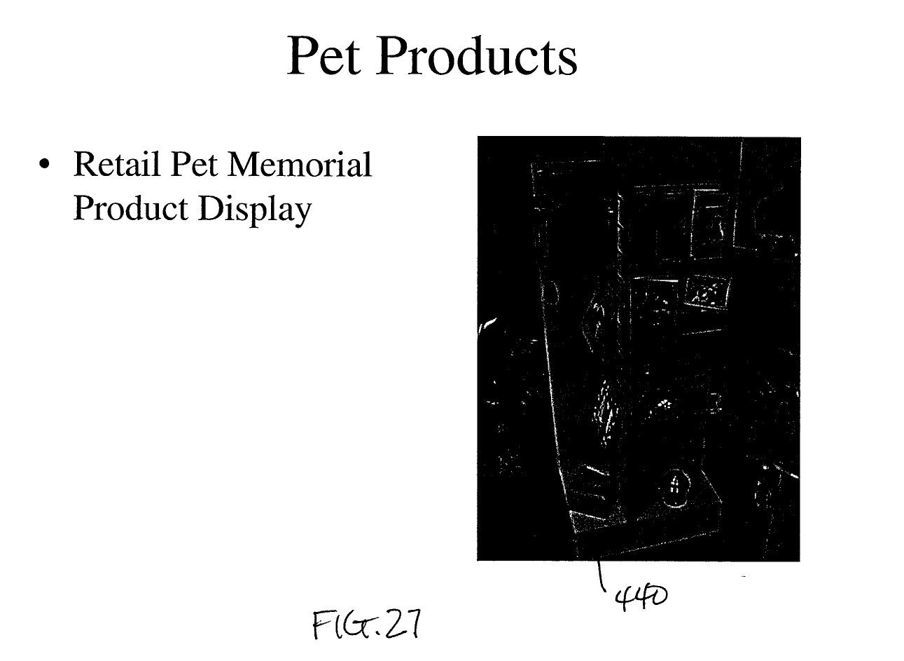

FIGS. 24-27 are retail pet memorial product displays including display stands 440 and 442. The pet memorial product displays could be displayed by the preferred provider in a retail setting.

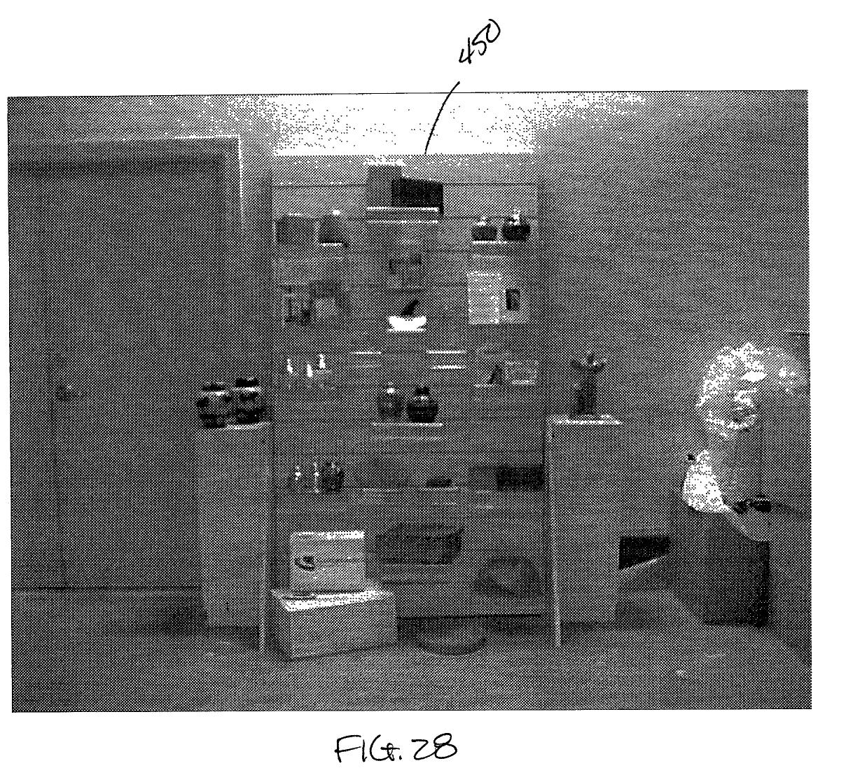

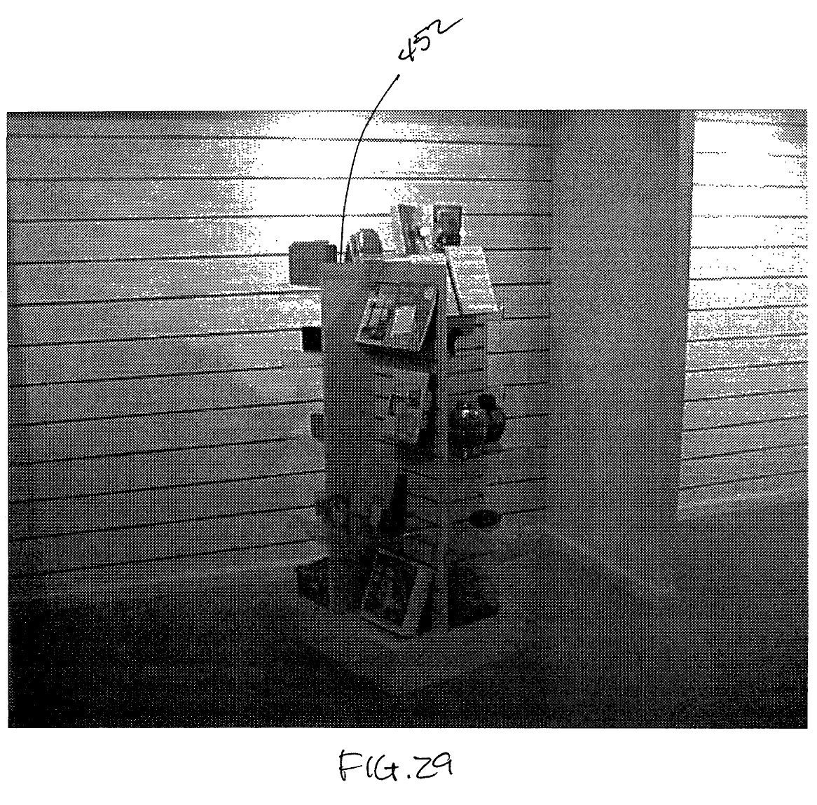

Referring now to FIGS. 28 and 29, these figures illustrate retail displays including display stands 450, 452 which can be utilized by the preferred provider in a retail setting to merchandise both pet life care products, services and information as well as pet death care products, services and information.

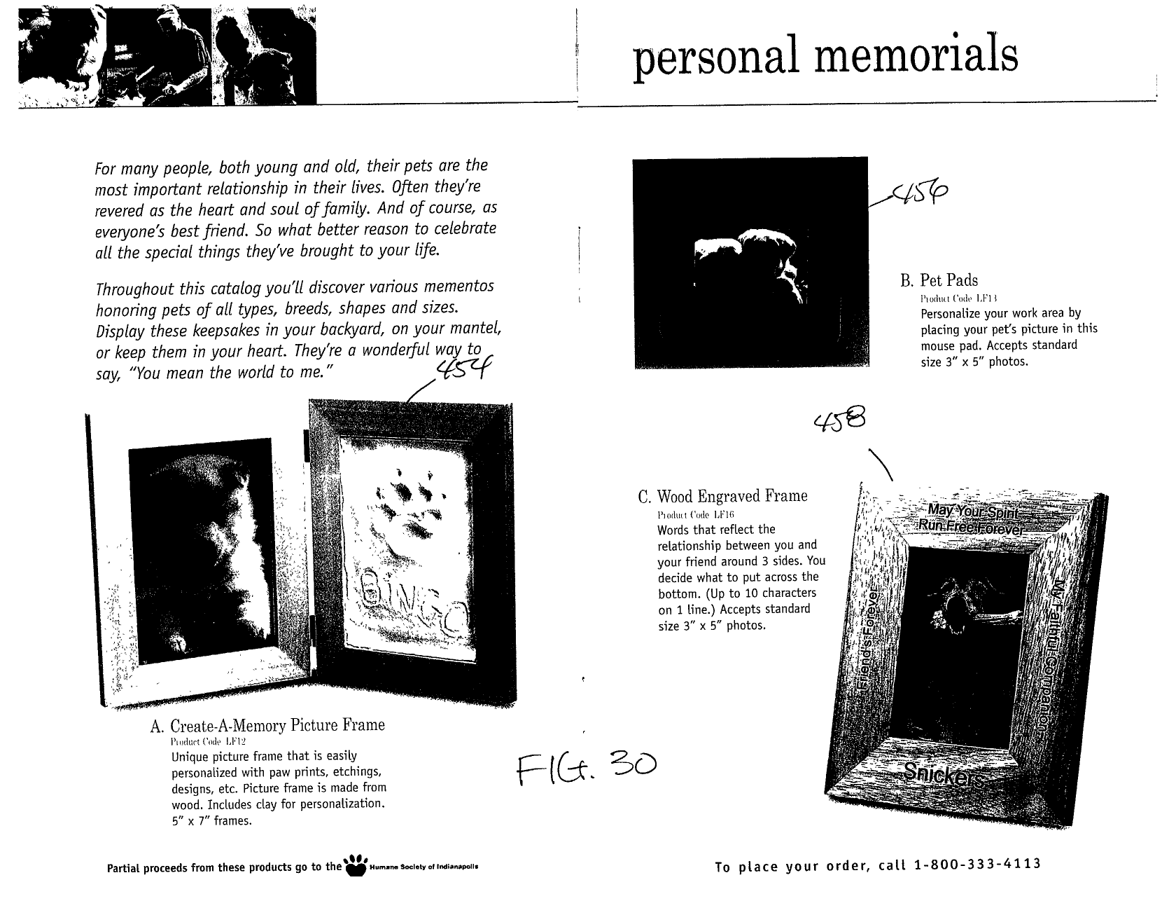

Referring now to FIGS. 30-35, these figures illustrate additional pet memorial products and/or refinements to the pet memorial products illustrated in the prior figures. FIGS. 30-33 illustrate personal pet memorials for memorializing a pet after death. More particularly, a create-a-memory picture frame 454 is personalizable with paw prints, etchings, designs, etc. The picture frame is made from wood and includes clay for personalization. A pet pad 456 allows one to personalize his or her work area by placing a pet's picture in this mouse pad. A wood engraved frame 458 includes words reflecting the relationship between the pet owner and the pet around three sides of the frame, with the pet's name being located on the bottom side of the frame.

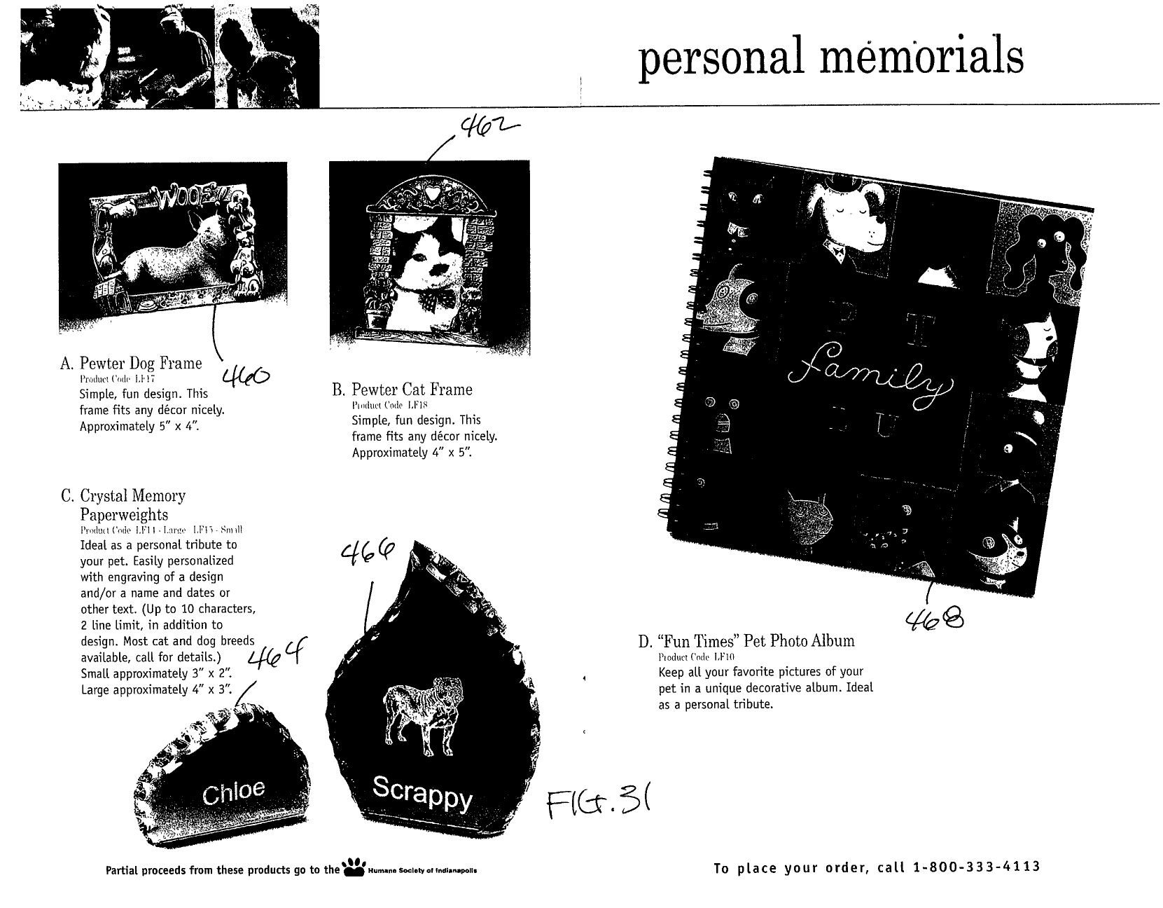

In FIG. 31, additional pewter pet frames 460 and 462 are illustrated. In addition, memorial crystal paperweights 464, 466 are ideal as a personal tribute to one's pet, and are easily engravable with the engraving of a design and/or name, dates and/or other text. FIG. 31 also illustrates a pet photo album 468 also ideal as a personal tribute to one's pet, in which one can keep all one's favorite pictures of the pet in the unique decorative album.

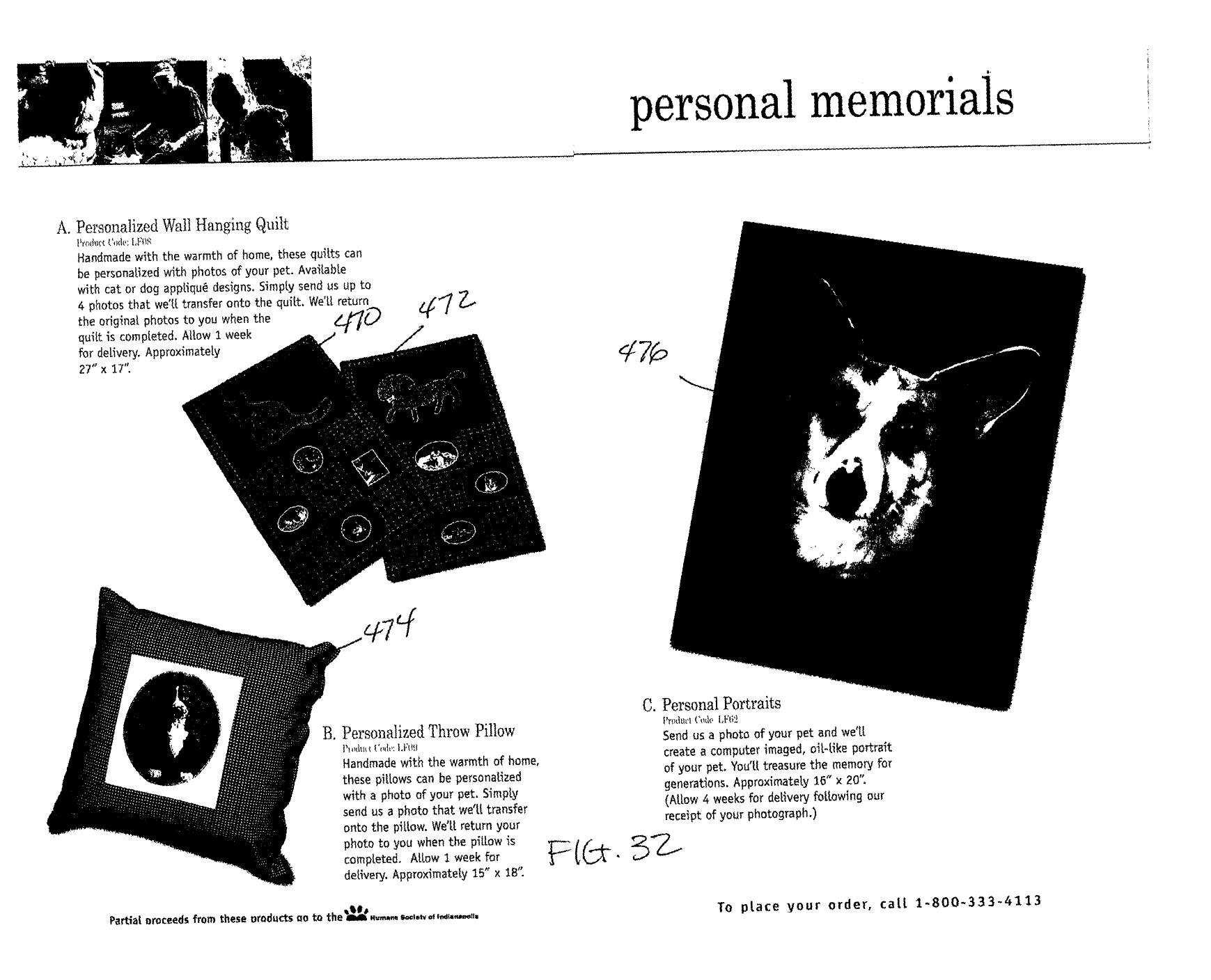

FIG. 32 illustrates wall hanging quilts 470, 472 which may include cat or dog applique designs as well as four photos of the pet. A personalized throw pillow 474 likewise includes a photo of the pet. A personal portrait 476 is an oil-like portrait of one's pet created from a photo of the pet by computer imaging.

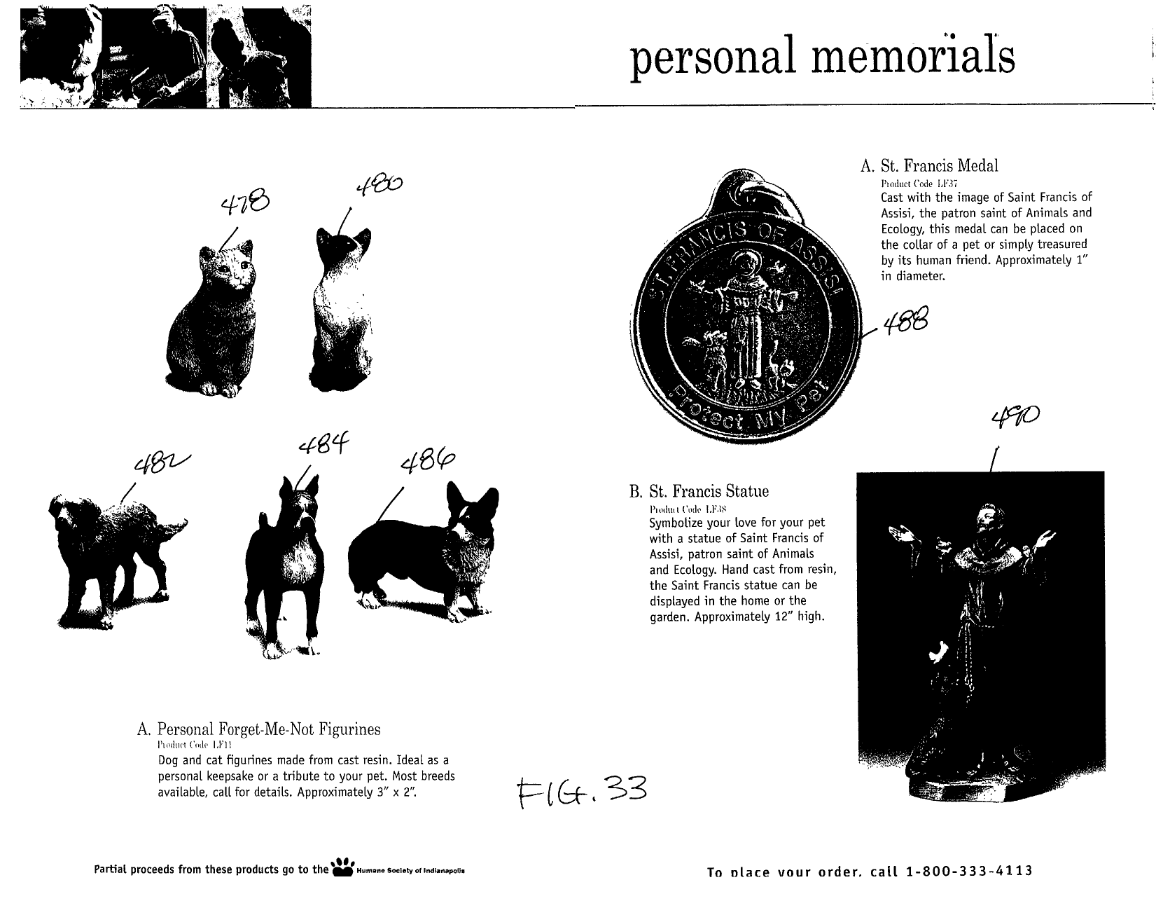

FIG. 33 illustrates pet forget-me-not figurines 478, 480, 482, 484 and 486 which are made from cast resin, and are ideal as a personal keepsake or tribute to one's pet. FIG. 33 also illustrates a St. Francis medal 488 and statue 490, St. Francis being the patron saint of animals and ecology. The medal 488 can be placed on the collar of a pet or simply treasured by its owner. The statue 490 is hand cast of resin, and can be displayed in the pet owner's home or garden.

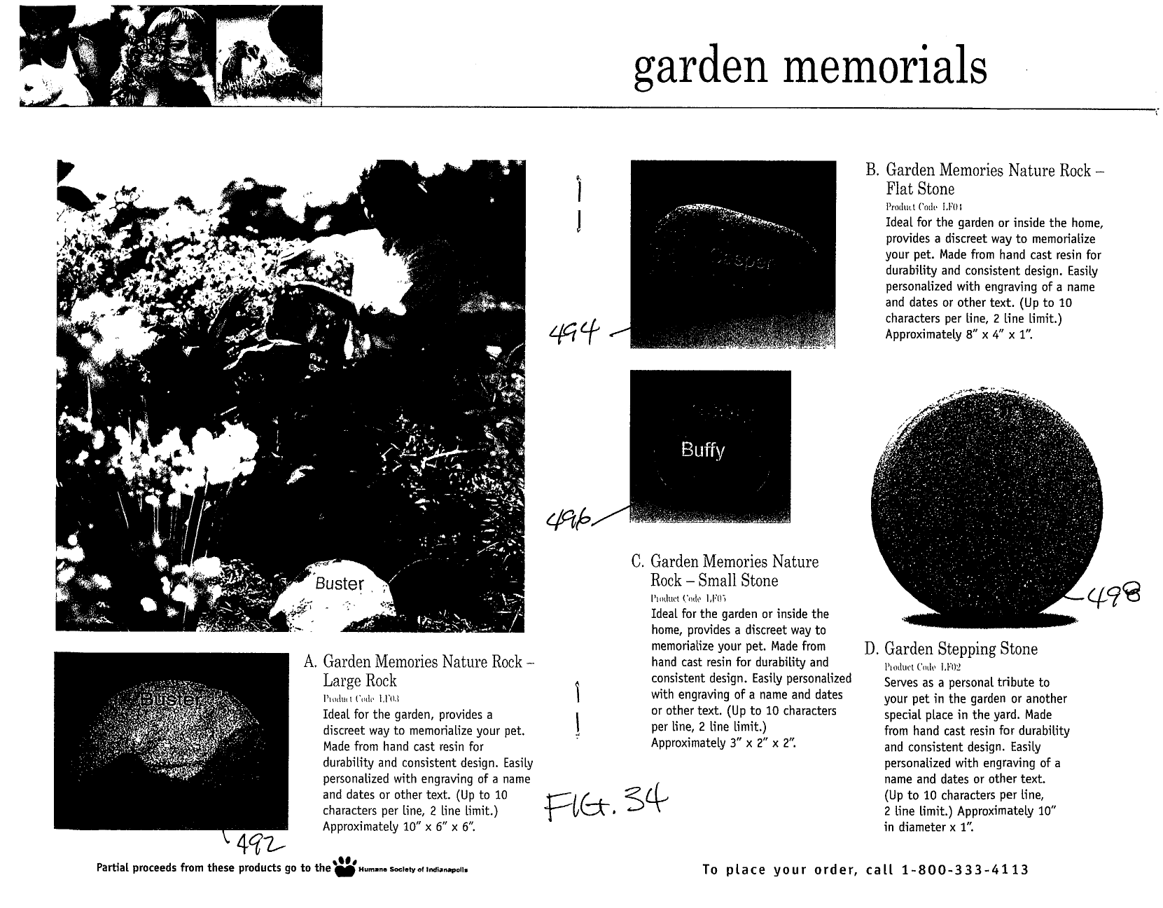

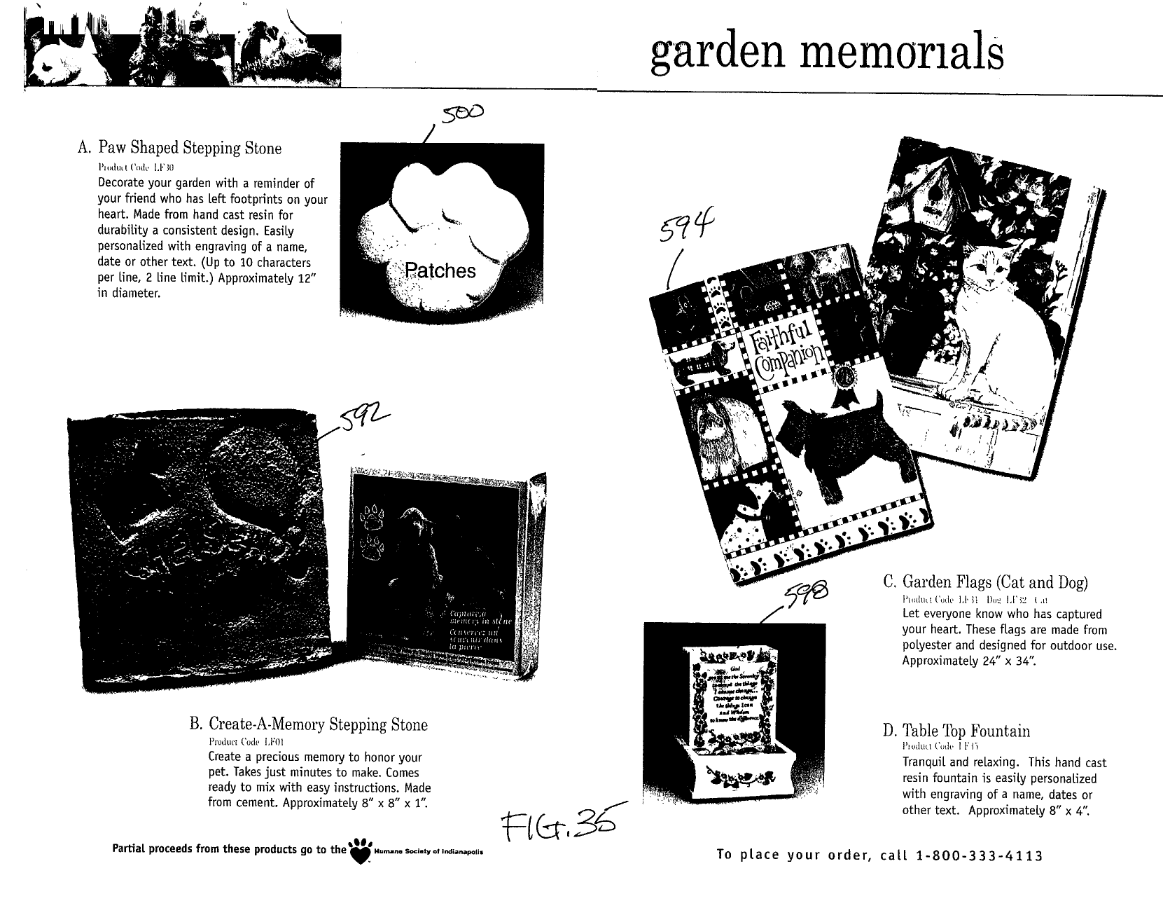

FIGS. 34 and 35 illustrate garden pet memorials for placement in the pet owner's lawn or garden to memorialize the life of the pet. A large nature rock 492 is ideal for a garden, is made from hand cast resin and is personalizable with engraving of a name or dates. Other variations are a flat stone 494, a small stone 496 and a stepping stone 498.

FIG. 35 illustrates a paw-shaped stepping stone 500, also made from cast resin and personalizable with engraving of names, dates or other text. A create-a-memory stepping stone 592 is a do-it-yourself garden stepping stone creatable by the pet owner out of concrete and may include an actual paw print of the pet. Further garden memorial pet products include garden flags 594, 596 and a tabletop fountain 598.

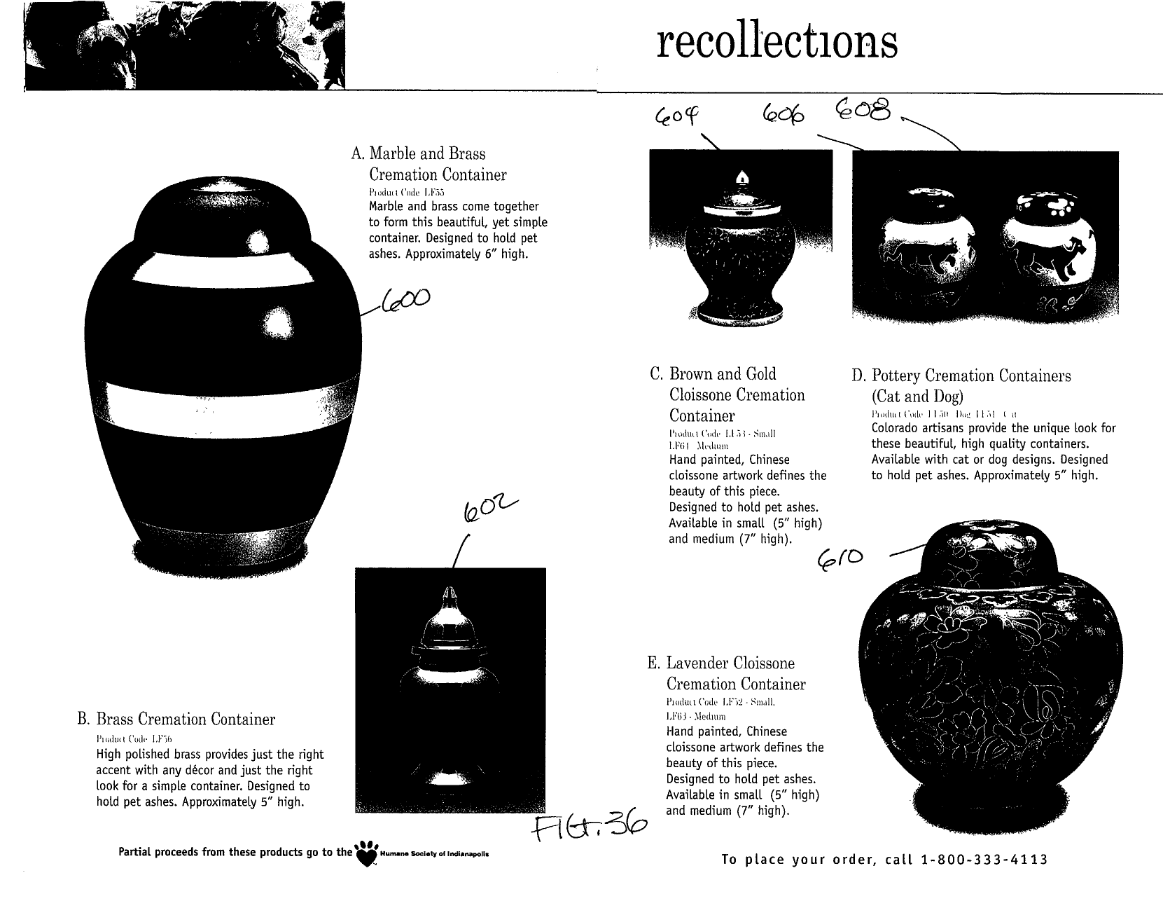

FIGS. 36-40 illustrate a number of pet cremation remains containers. FIG. 36 illustrates a marble and brass cremation container 600, a brass cremation container 602, a brown and gold cloissone cremation container 604, pottery cremation containers 606, 608 and a lavendar cloissone cremation container 610.

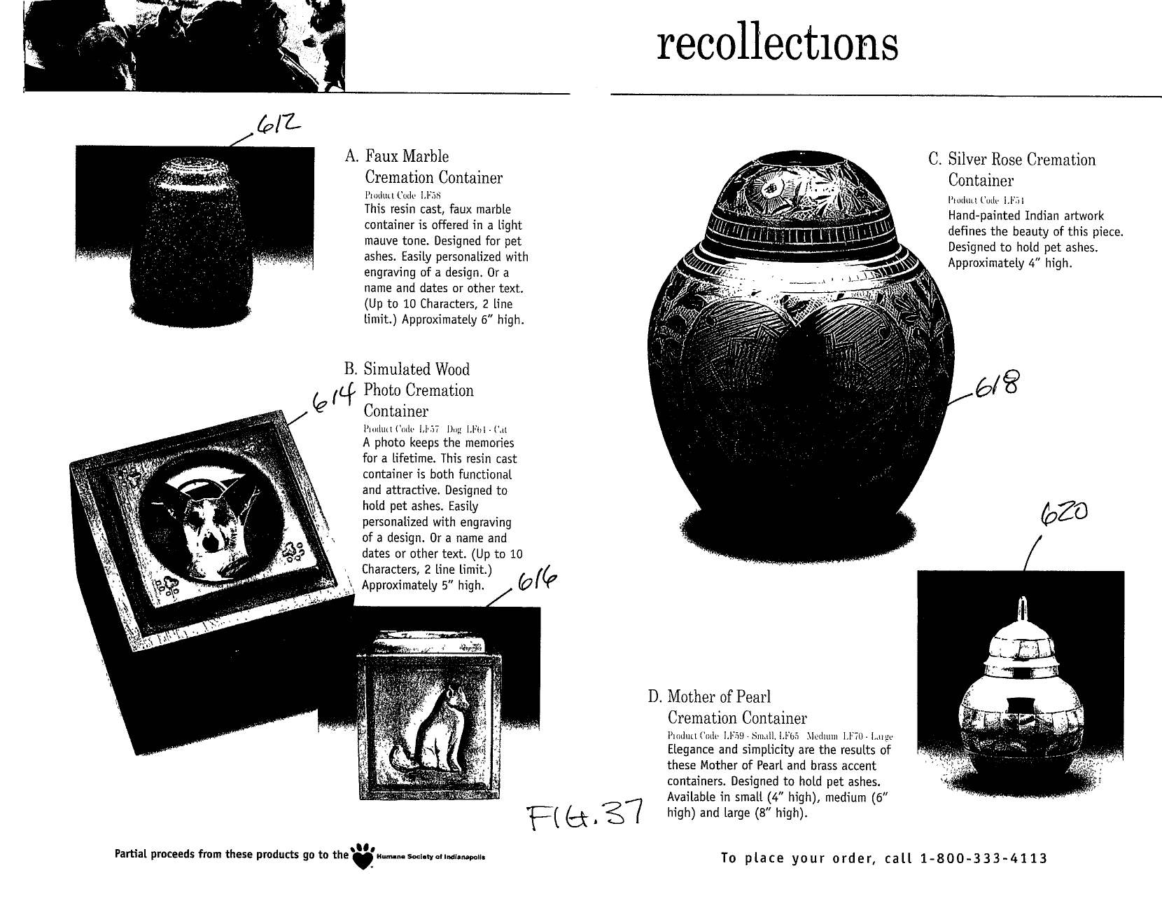

FIG. 37 illustrates a faux marble cremation container 612, simulated wood photo cremation containers 614, 616 including a picture frame on the top thereof, a silver rose cremation container 618 and a mother-of-pearl cremation container 620.

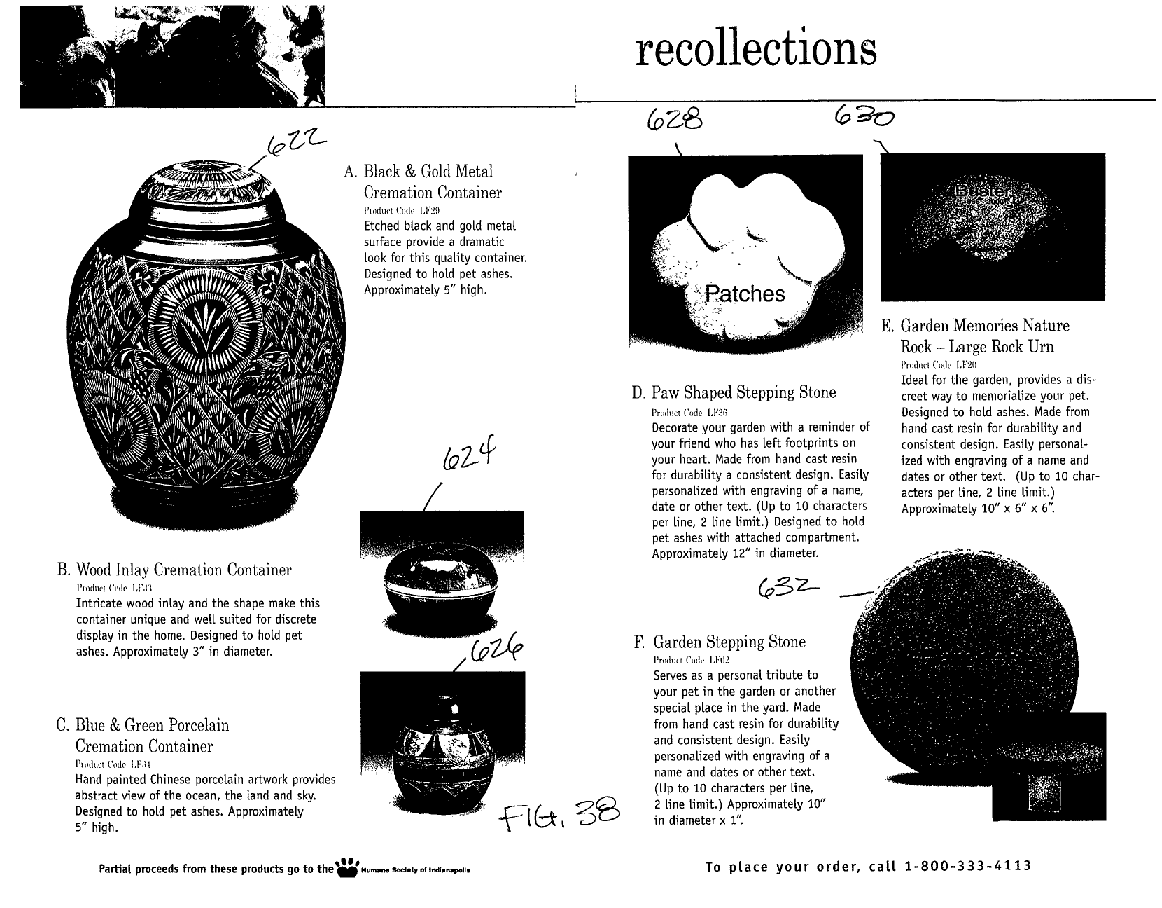

FIG. 38 illustrates a black and gold metal cremation container 622, a wood inlay cremation container 624, a blue and green porcelain cremation container 626, a paw-shaped stepping stone cremation container 628, a large rock urn 630 and a garden stepping stone cremation container 632.

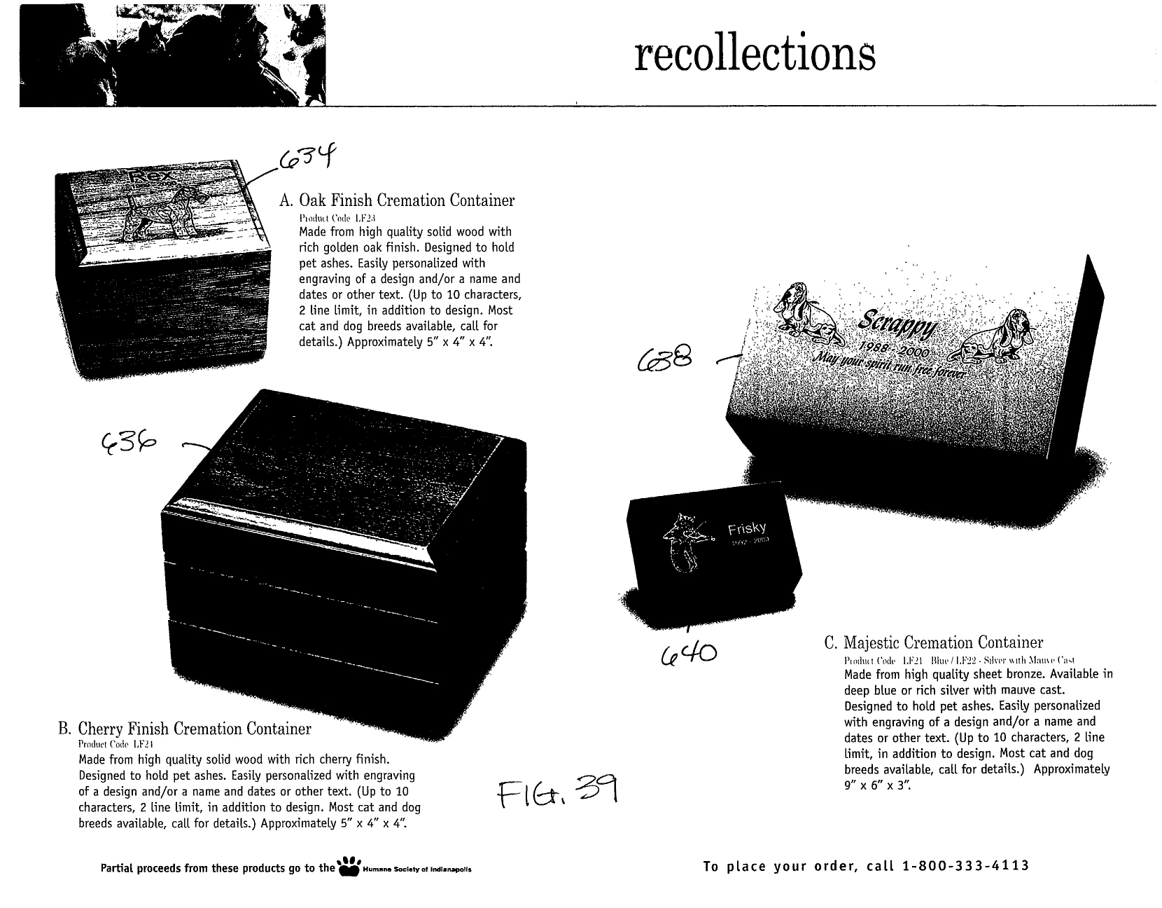

FIG. 39 illustrates an oak 634 and a cherry 636 finish wood cremation containers, and bronze 638, 640 cremation containers.

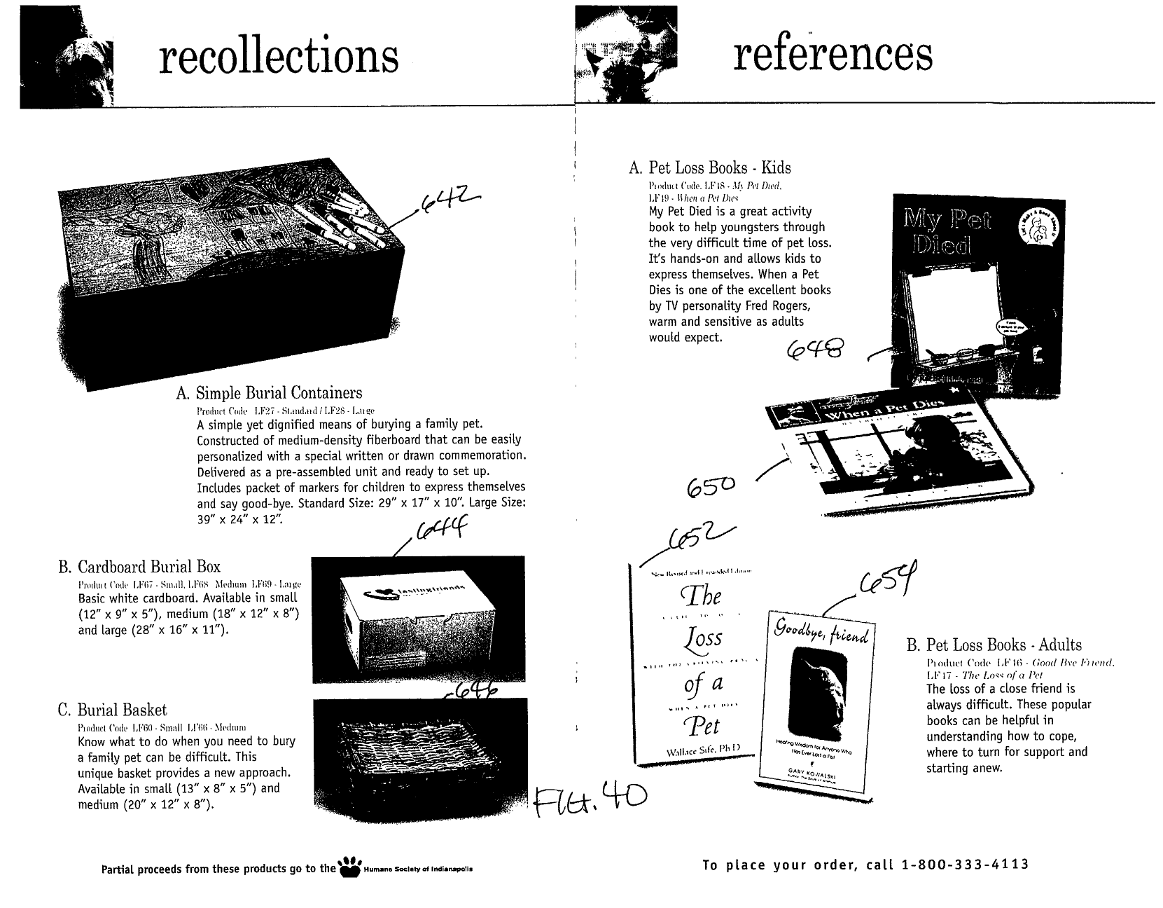

Finally, FIG. 40 illustrates a simple burial container 642 constructed of medium density fiberboard which is easily personalized with writings, drawings or the like, a cardboard burial box 644 and a burial basket 646. FIG. 40 also illustrates children's pet loss books 648 and 650 and adult pet loss books 652, 654 which provide help for the pet owner in understanding how to cope with the death of a pet, where to turn for support and how to start anew.

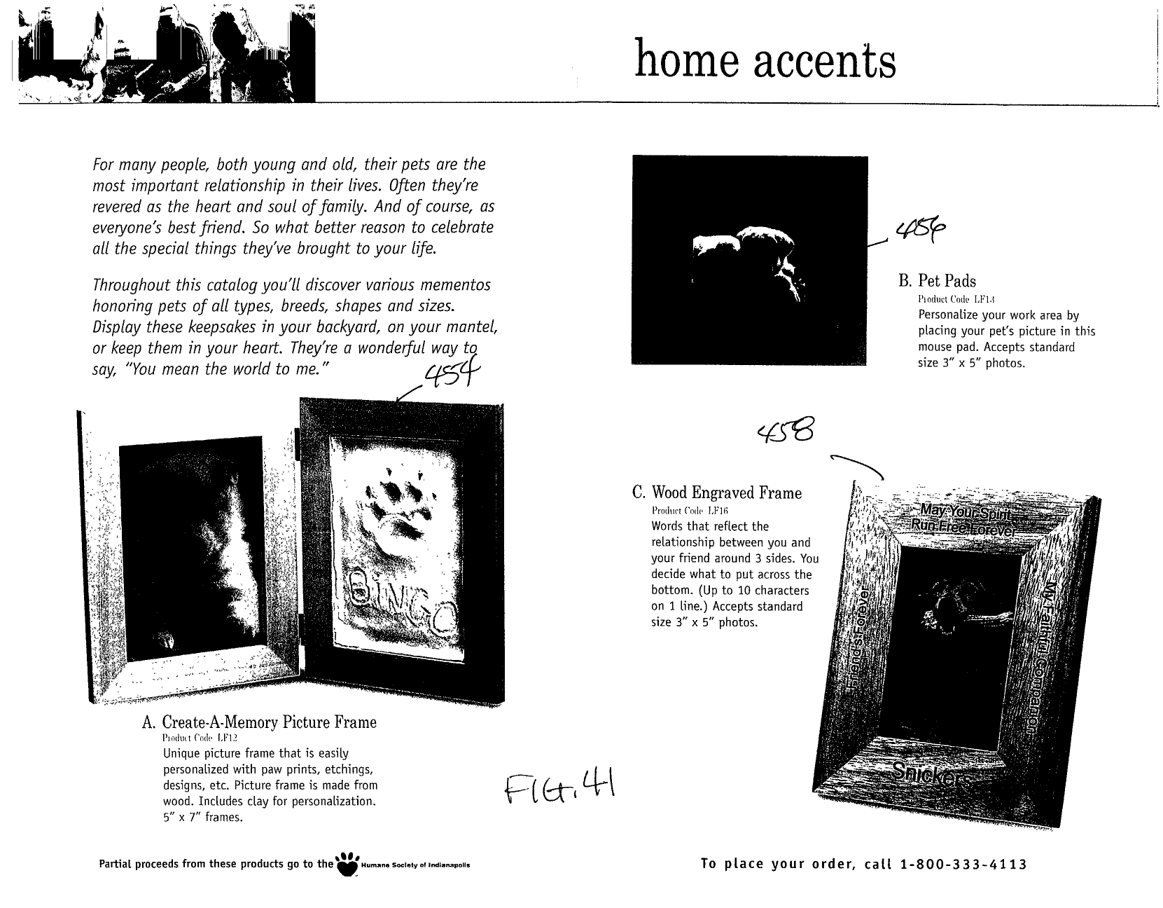

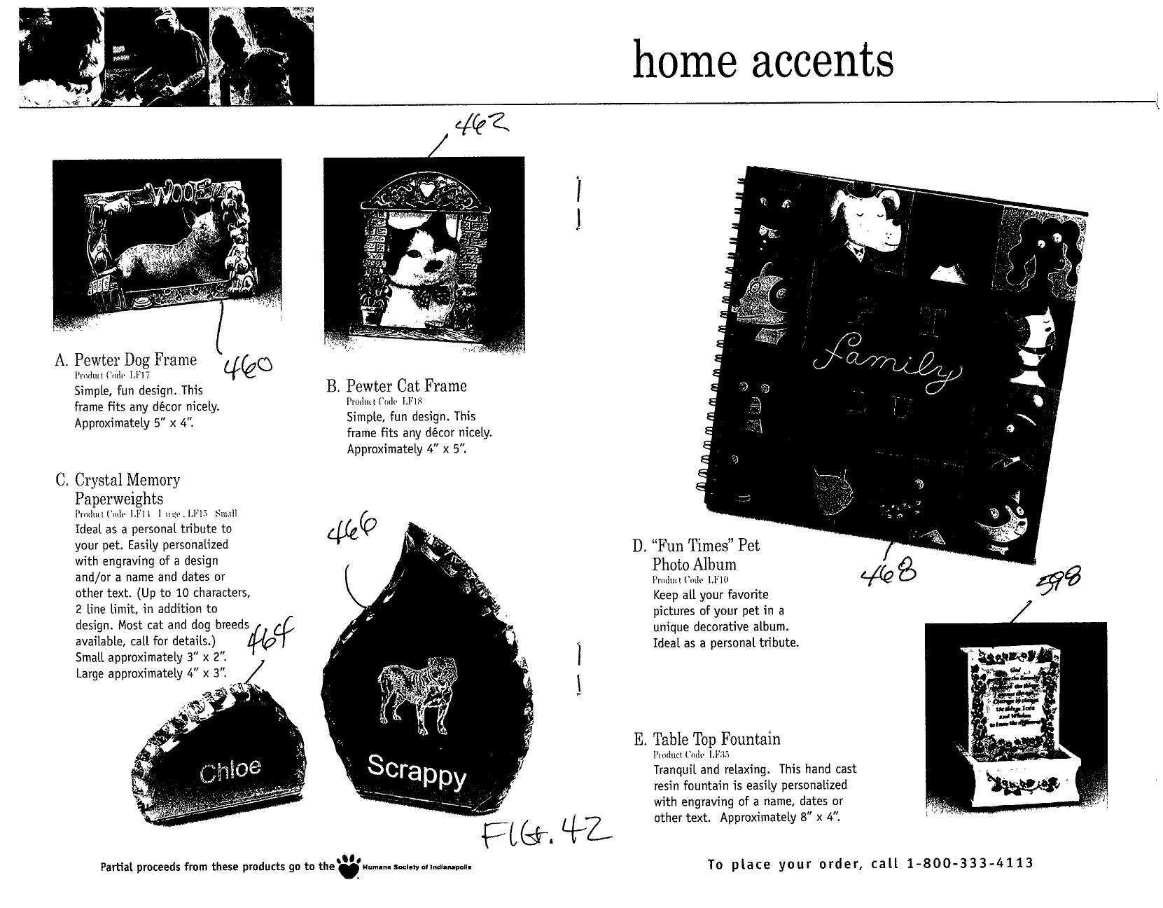

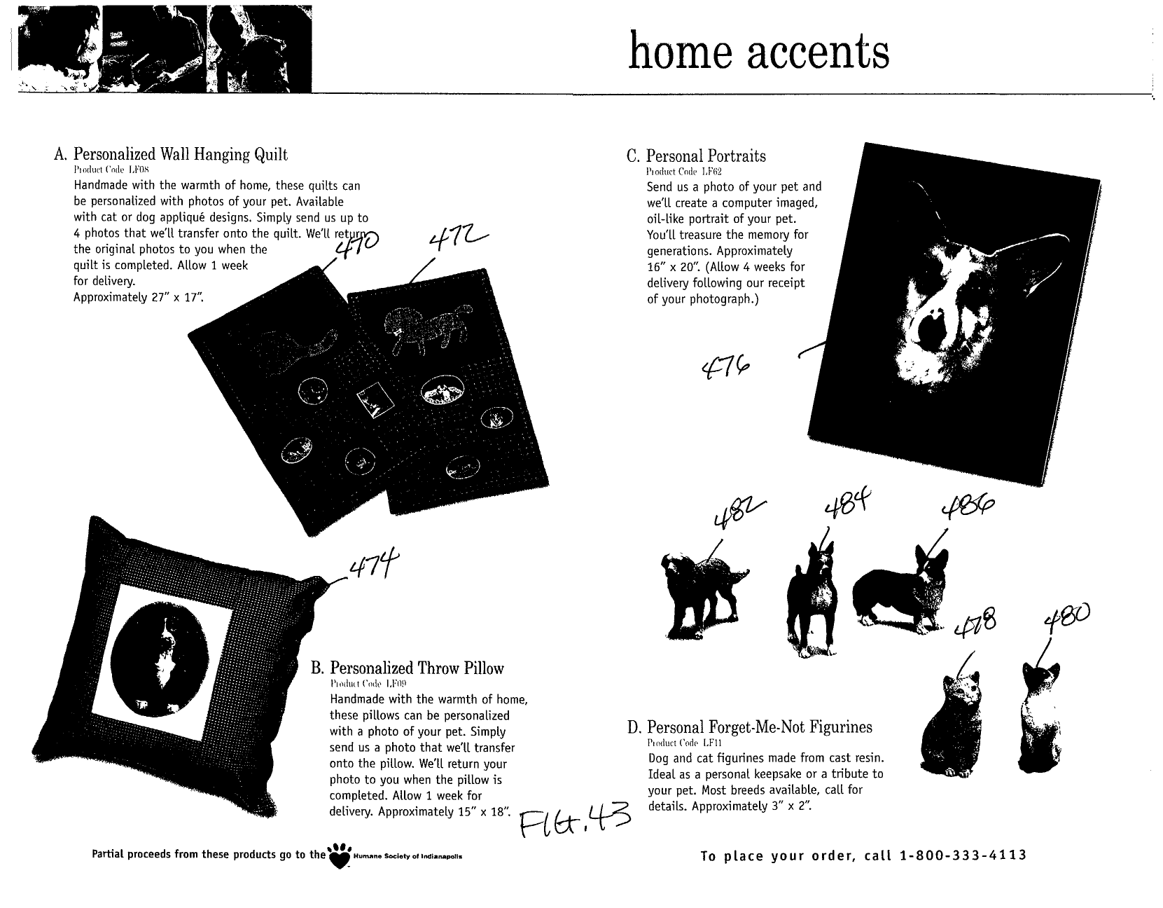

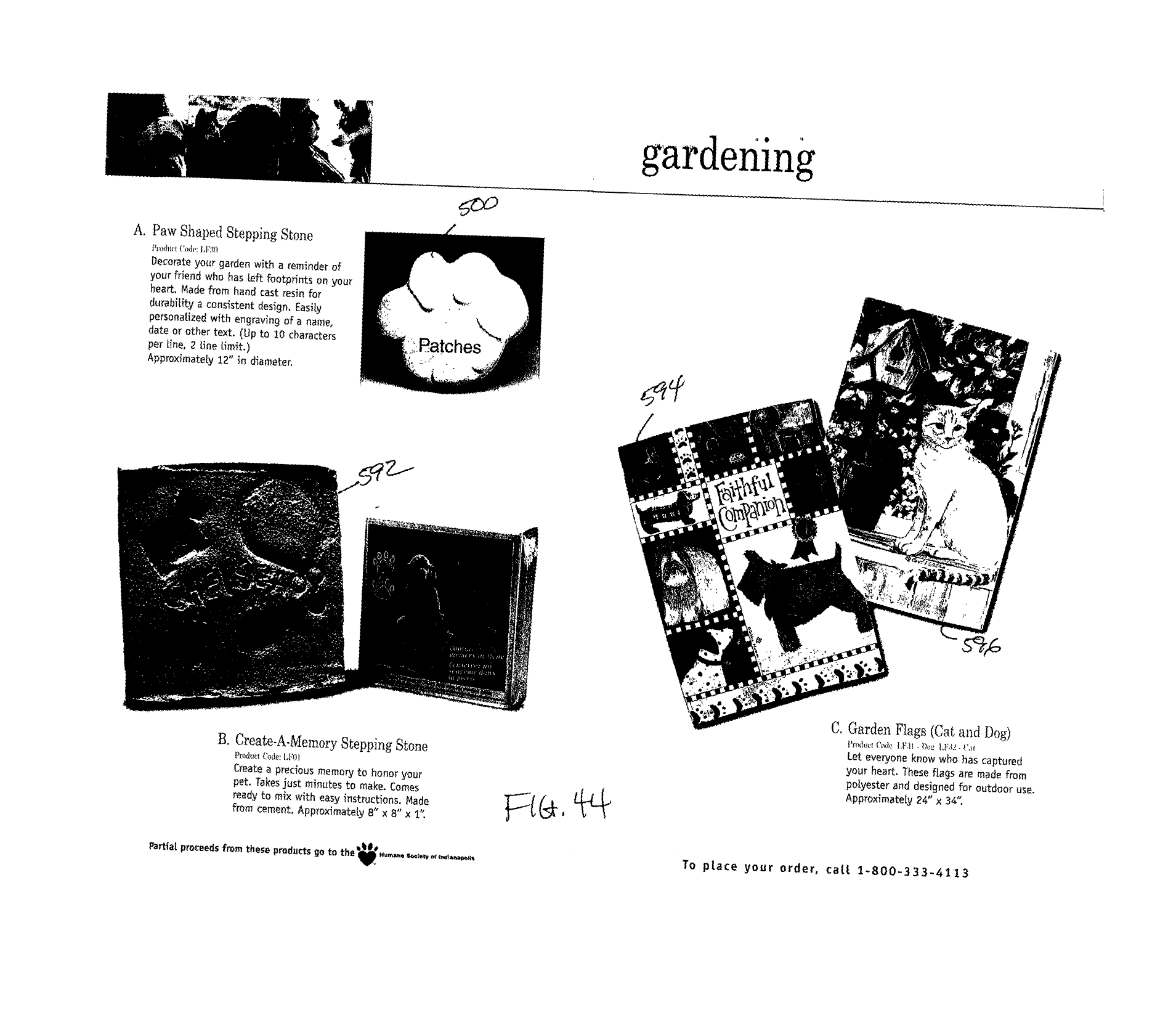

A number of the products of the preceding figures can also be utilized during the life of a pet. For example, FIGS. 41-44 illustrate a number of the previously discussed products which can be utilized in the home of the pet owner during the life of the pet as home accents.

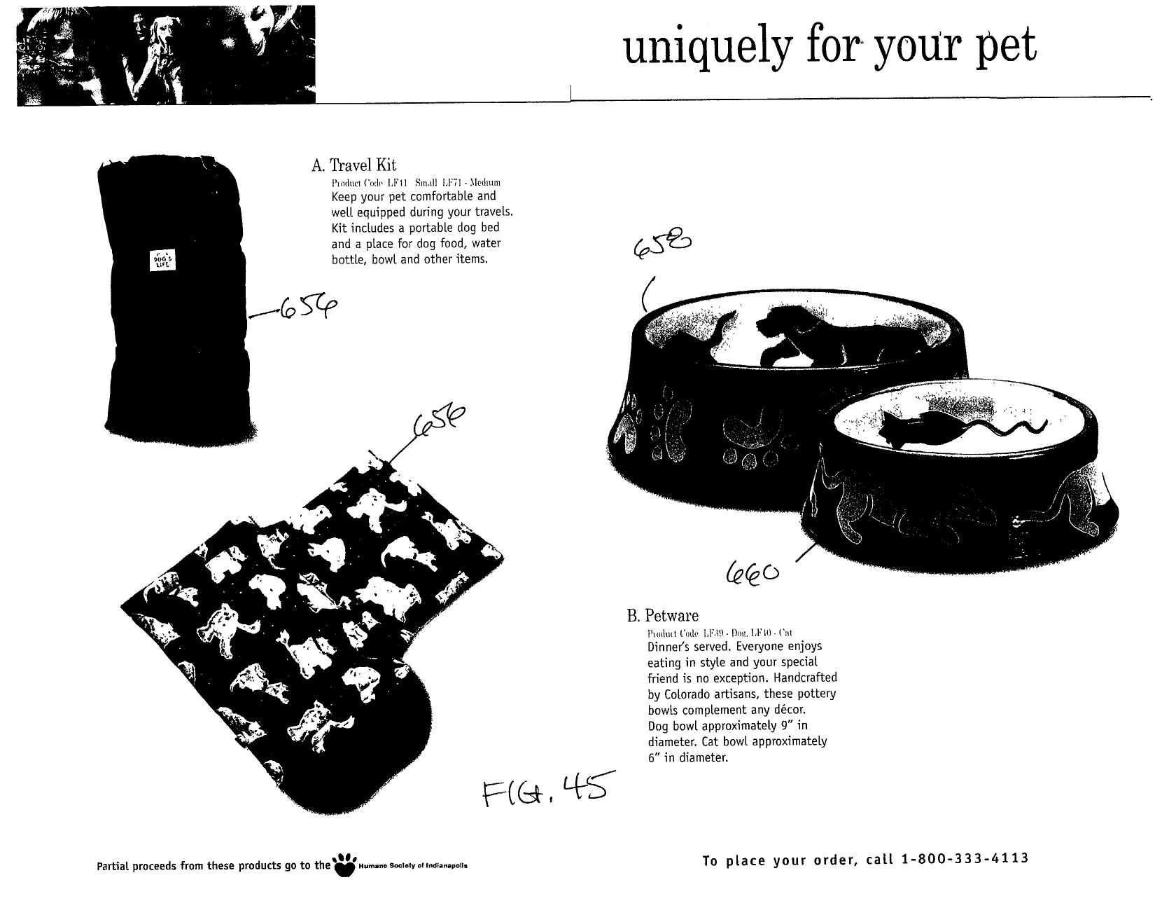

Additional pet life care products are illustrated in FIG. 45 and include a travel kit 656 which includes a portable dog bed and storage for dog food, water bottle, bowl and other items, and petware 658, 660.

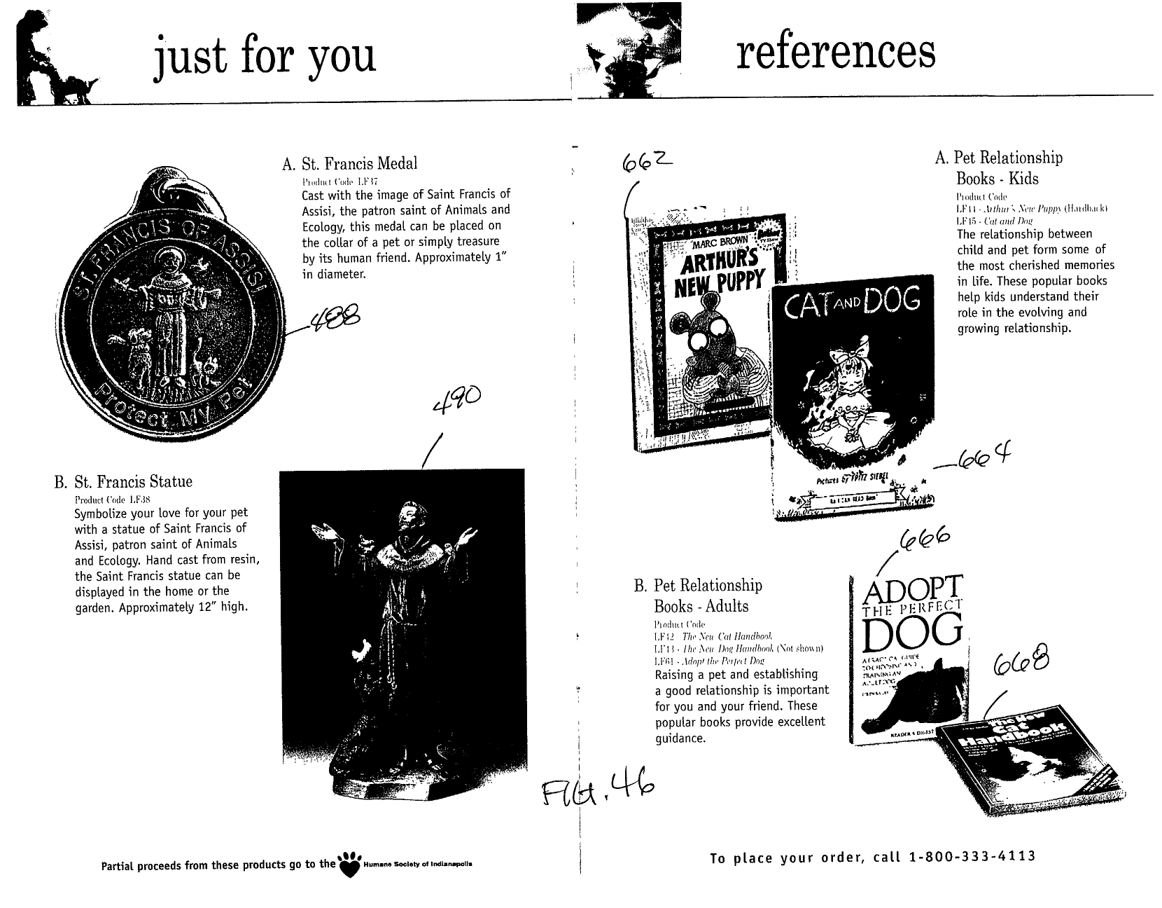

Lastly, FIG. 46 illustrates children and adult pet relationship books 662, 664, 666, 668 which are instructive and informative for pet owners relative to raising the pet, establishing a good relationship with the pet and the like.

Those skilled in the art will readily recognize numerous adaptations and modifications which can be made to the present invention which will result in an improved method of providing pet care products, services and information, yet all of which will fall within the spirit and scope of the present invention as defined in the following claims. Accordingly, the invention is to be limited only by the scope of the following claims and their equivalents.

What is claimed is:

1. A method of providing pet care products, services and information comprising:
receiving pet care products, services and information from a supplier of pet care products, services and information; and
as a preferred provider, dispensing the pet care products, services and information to pet owners.

2. The method of claim 1 wherein the pet care products are pet life care products.

3. The method of claim 1 wherein the pet care products are pet death care products.

4. The method of claim 1 wherein the preferred provider is a veterinarian.

5. The method of claim 4 wherein the veterinarian is a network of veterinarians.

6. The method of claim 1 wherein the preferred provider is a pet store.

7. The method of claim 6 wherein the pet store is a nationwide chain of pet stores.

8. The method of claim 1 wherein the preferred provider is a pet cemetery.

9. The method of claim 8 wherein the pet cemetery is a nationwide chain of pet cemeteries.

10. The method of claim 1 wherein the preferred provider is an animal humane shelter.

11. The method of claim 10 wherein the animal humane shelter is a nationwide chain of animal humane shelters.

12. The method of claim 3 wherein the pet death care products include pet caskets, urns, memorial markers and products and printed matter.

13. The method of claim 3 wherein the services include cremation and burial, and funeral and memorial services.

14. The method of claim 3 wherein the information includes information about grief counseling and death/grief support groups.

15. A method of equipping a preferred provider with pet care products, services and information to be dispensed to pet owners comprising:
selecting a preferred provider to dispense pet care products, services and information to pet owners; and
supplying the preferred provider with pet care products, services and information to be dispensed by the preferred provider to pet owners.

16. The method of claim 15 wherein the pet care products are pet life care products.

17. The method of claim 15 wherein the pet care products are pet death care products.

18. The method of claim 15 wherein the preferred provider is a veterinarian.

19. The method of claim 18 wherein the veterinarian is a network of veterinarians.

20. The method of claim 15 wherein the preferred provider is a pet store.

21. The method of claim 20 wherein the pet store is a nationwide chain of pet stores.

22. The method of claim 15 wherein the preferred provider is a pet cemetery.

23. The method of claim 22 wherein the pet cemetery is a nationwide chain of pet cemeteries.

24. The method of claim 15 wherein the preferred provider is an animal humane shelter.

25. The method of claim 24 wherein the animal humane shelter is a nationwide chain of animal humane shelters.

26. The method of claim 17 wherein the products include pet caskets, urns, memorial markers and products and printed matter.

27. The method of claim 17 wherein the services include cremation and burial, and funeral and memorial services.

28. The method of claim 17 wherein the information includes information about grief counseling and death/grief support groups.

29. A method of providing pet care products, services and information comprising:
receiving pet life and death care products, services and information from a supplier of pet life and death care products, services and information; and
as a preferred provider, dispensing the pet life and death care products, services and information to pet owners.

30. A method of equipping a preferred provider with pet care products, services and information to be dispensed to pet owners comprising:
selecting a preferred provider to dispense pet life and death care products, services and information to pet owners; and
supplying the preferred provider with pet life and death care products, services and information to be dispensed by the preferred provider to pet owners.

31. A method of merchandising pet care products, services and information comprising:
providing a display stand;
displaying pet life care products, services and information on the display stand; and
displaying pet death care products, services and information on the display stand.

32. The method of claim 31 wherein the display stand with products, services and information is displayed at a location of a preferred provider of the products, services and information, and wherein the preferred provider has been selected by the supplier of the products, services and information to dispense same.
